(19) United States
(12) Patent Application Publication
(10) Pub. No.: US 2026/0162014 A1
(43) Pub. Date: Jun. 11, 2026

(54) EXCITABLE INTEGRAL REINFORCEMENT LEARNING FOR CONTINUOUS-TIME CONTROL

(71) Applicants: Jennie Si, Phoenix, AZ (US); Brent Wallace, Phoenix, AZ (US)

(72) Inventors: Jennie Si, Phoenix, AZ (US); Brent Wallace, Phoenix, AZ (US)

(73) Assignee: Arizona Board of Regents on Behalf of Arizona State University, Scottsdale, AZ (US)

(21) Appl. No.: 19/407,833

(22) Filed: Dec. 3, 2025

Related U.S. Application Data
(60) Provisional application No. 63/729,025, filed on Dec. 6, 2024.

(51) Int. Cl. G06N 20/00

(52) U.S. Cl. CPC G06N 20/00

(57) ABSTRACT

Techniques are presented for refining a control policy for a continuous-time system using reinforcement learning. A multi-injection excitation process can be applied to generate persistently excited state information. The continuous-time system may be decomposed into sub-loops according to physical or functional partitions. State-action trajectory data are obtained while the system operates under a policy, and the data are used to train a model to produce an updated policy for a nonlinear continuous-time system. An integral reinforcement learning process refines the updated policy using trajectory information to reduce approximation error during learning. The refined model is then output with the updated policy.

### CLAIM OF PRIORITY

This application claims the benefit of U.S. Patent Application No. 63/729,025, filed 6 Dec. 2024, the entire contents of which is incorporated herein by reference.

### GOVERNMENT RIGHTS AND GOVERNMENT AGENCY SUPPORT NOTICE

This invention was made with government support under 1808752 and 2211740 awarded by the National Science Foundation. The government has certain rights in the invention.

### TECHNICAL FIELD

Aspects of the disclosure relate generally to machine learning, control theory, and broader computational techniques for processing information and refining decision policies in dynamic environments.

### BACKGROUND

Continuous-time reinforcement learning is used to address decision-making tasks in settings where system behavior evolves according to continuous dynamics. Conventional approaches adapt concepts from discrete-time reinforcement learning, such as value function approximation, policy optimization, and actor-critic structures, to operate with differential equations and continuous-time trajectories. These techniques may rely on approximations of system dynamics and real-time updates to policies and value estimates. Classical control frameworks, including regulator design methods and iterative approaches for solving associated matrix equations, provide alternative tools for stabilizing and optimizing dynamic systems. In practice, both machine learning methods and classical control techniques encounter challenges related to numerical conditioning, scalability, system excitation, and the availability of reliable state-action data.

### SUMMARY

In general, this disclosure describes techniques for refining a control policy for a continuous-time system using reinforcement learning processes. In certain examples, multi-injection excitation may be applied to the system to generate state information that is persistently excited. The continuous-time system can be optionally decomposed into multiple sub-loops according to physical or functional partitions. State-action trajectory data may be obtained while the system operates under an existing policy, and this data can be used to train a model configured to generate an updated policy for a nonlinear continuous-time system. An integral reinforcement learning process may be applied to refine the updated policy using the trajectory data in a manner that reduces approximation error during learning.

Further examples relate to forming regression updates based on nominal linearization information, generating integral reinforcement signals tied to specified cost representations, or determining critic parameters using regression equations derived from the trajectory data. Additional examples may involve decentralized learning across sub-loops or reusing collected trajectory data for successive policy updates. The updated model including the refined policy may then be output for application in controlling the continuous-time system.

According to one example, a method for refining a control policy for a continuous-time system includes applying multi-injection excitation to a continuous-time system to generate persistently excited state information. In one example, the method includes optionally decomposing the continuous-time system into a plurality of sub-loops based on physical or functional partitions. In at least one example, the method includes obtaining state-action trajectory data from the continuous-time system while operating under an operating policy. According to such examples, the method includes training a model using reinforcement learning to obtain an updated policy for a nonlinear continuous-time system. In another example, the method includes updating the operating policy using an integral reinforcement learning process configured to reduce approximation error during learning based at least in part on the state-action trajectory data. In some examples, the method includes outputting the model with the updated policy.

According to another example, an apparatus for refining a control policy for a continuous-time system includes at least one memory storing instructions and processing circuitry in communication with the at least one memory, the processing circuitry configured to apply multi-injection excitation to a continuous-time system to generate persistently excited state information. In one example, the apparatus includes processing circuitry configured to decompose the continuous-time system into a plurality of sub-loops based on physical or functional partitions. In at least one example, the apparatus includes processing circuitry configured to obtain state-action trajectory data from the continuous-time system while operating under an operating policy. According to such examples, the apparatus includes processing circuitry configured to train a model using reinforcement learning to obtain an updated policy for a nonlinear continuous-time system. In another example, the apparatus includes processing circuitry configured to update the operating policy using an integral reinforcement learning process configured to reduce approximation error during learning based at least in part on the state-action trajectory data. In some examples, the apparatus includes processing circuitry configured to output the model with the updated policy.

According to yet another example, a non-transitory computer-readable medium stores instructions that, when executed by processing circuitry, cause the processing circuitry to apply multi-injection excitation to a continuous-time system to generate persistently excited state information. In one example, the non-transitory computer-readable medium stores instructions that cause the processing circuitry to decompose the continuous-time system into a plurality of sub-loops based on physical or functional partitions. In at least one example, the non-transitory computer-readable medium stores instructions that cause the processing circuitry to obtain state-action trajectory data from the continuous-time system while operating under an operating policy. According to such examples, the non-transitory computer-readable medium stores instructions that cause the processing circuitry to train a model using reinforcement learning to obtain an updated policy for a nonlinear continuous-time system. In another example, the non-transitory computer-readable medium stores instructions that cause the processing circuitry to update the operating policy using an integral reinforcement learning process configured to reduce approximation error during learning based at least in part on the state-action trajectory data. In some examples, the non-transitory computer-readable medium stores instructions that cause the processing circuitry to output the model with the updated policy.

According to a particular example, there is a device which includes means for applying multi-injection excitation to a continuous-time system to generate persistently excited state information. In one example, the device includes means for optionally decomposing the continuous-time system into a plurality of sub-loops based on physical or functional partitions. In at least one example, the device includes means for obtaining state-action trajectory data from the continuous-time system while operating under an operating policy. According to such examples, the device includes means for training a model using reinforcement learning to obtain an updated policy for a nonlinear continuous-time system. In another example, the device includes means for updating the operating policy using an integral reinforcement learning process configured to reduce approximation error during learning based at least in part on the state-action trajectory data. In some examples, the device includes means for outputting the model with the updated policy.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of a computing device, in accordance with aspects of this disclosure.

FIG. 2 illustrates an example negative feedback structure that may be utilized by the EIRL framework, in accordance with aspects of this disclosure.

FIG. 3 illustrates Table 1, which summarizes state-action data requirements and corresponding dynamical information for multiple continuous-time system types under excitable integral reinforcement learning (EIRL) and decentralized excitable integral reinforcement learning (dEIRL), in accordance with aspects of this disclosure.

FIGS. 4A and 4B depict closed-loop frequency responses used to illustrate challenges associated with probing noise injection within excitable integral reinforcement learning processes, in accordance with aspects of this disclosure.

FIG. 5 depicts Algorithm 1, summarizing the EIRL and dEIRL execution procedure in both single-injection (SI) and multi-injection (MI) modes, in accordance with aspects of the disclosure.

FIG. 6 depicts Table 2, which summarizes learning-hyperparameter selections used across an algorithm and includes sample periods T_{s,j}, sample counts Iⱼ, and iteration limits

$${i}_{j}^{*} .$$

FIG. 7 depicts Table 3, which summarizes conditioning characteristics associated with learning matrices Θᵢⱼ generated during policy-update regression within excitable integral reinforcement learning (EIRL) and decentralized excitable integral reinforcement learning (dEIRL), in accordance with aspects of the disclosure.

FIG. 8 depicts a plot panel, which presents evaluation 1 condition number versus iteration count i for the learning matrices used within excitable integral reinforcement learning (EIRL) and decentralized excitable integral reinforcement learning (dEIRL), in accordance with aspects of the disclosure.

FIGS. 9A and 9B depict plot panels, which present evaluation 1 weight responses v(Pᵢ) associated with critic-parameter updates within integral reinforcement learning (IRL), excitable integral reinforcement learning (EIRL), and single-injection excitable integral reinforcement learning (SI-EIRL), in accordance with aspects of the disclosure.

FIG. 10 depicts Table 4 within dEIRL solution optimality recovery, which shows the policy error reduction

$${K}_{i , j} - {K}_{j}^{*}$$

from the initial policies K_{0,1}, K_{0,2} in accordance with aspects of the disclosure.

FIG. 11 depicts Table 5, presented using closed-loop step response characteristics, which shows the closed-loop step response characteristics in each loop j, in accordance with aspects of the disclosure.

FIG. 12 depicts closed-loop 1° flight path angle (FPA) step response behavior for a 25% lift-coefficient modeling error ν=0.75, in accordance with aspects of the disclosure.

FIG. 13 is a flow diagram illustrating an example method for refining a control policy for a continuous-time system, in accordance with aspects of this disclosure.

Like reference characters denote like elements throughout the text and figures.

### DETAILED DESCRIPTION

In general, this disclosure describes techniques for refining a control policy for a continuous-time system using reinforcement learning processes. In certain examples, multi-injection excitation may be applied to the system to generate state information that is persistently excited. The continuous-time system can be optionally decomposed into multiple sub-loops according to physical or functional partitions. State-action trajectory data may be obtained while the system operates under an existing policy, and this data can be used to train a model configured to generate an updated policy for a nonlinear continuous-time system. An integral reinforcement learning process may be applied to refine the updated policy using the trajectory data in a manner that reduces approximation error during learning.

Further examples relate to forming regression updates based on nominal linearization information, generating integral reinforcement signals tied to specified cost representations, or determining parameters using regression equations derived from the trajectory data. Additional examples may involve decentralized learning across sub-loops or reusing collected trajectory data for successive policy updates. The updated model including the refined policy may then be output for application in controlling the continuous-time system.

Additional examples relate to techniques for implementing excitable integral reinforcement learning in continuous-time environments. In certain implementations, EIRL processes can incorporate design considerations informed by input-output behaviors observed in classical control theory, including structures that may promote persistent excitation and support stable numerical behavior during policy updates. These approaches may integrate reinforcement learning with control-oriented insights to support reliable data collection, value estimation, and policy refinement.

Continuous-time reinforcement learning processes may draw on principles from adaptive dynamic programming, which can iteratively approximate value functions or policies for dynamic systems. Such processes may operate with differential equation models, continuous-time value representations, or actor-critic structures, and may be applied to systems that operate under real-time computational constraints. These techniques may be extended to nonlinear control settings and can operate in conjunction with the EIRL processes described herein.

In some cases, system dynamics may permit a physically motivated separation into multiple dynamical loops. EIRL techniques may use this structure to divide the control problem into a collection of subproblems, which may support decentralized representations and updates tailored to each loop. When applied to affine nonlinear systems, these techniques may contribute to stable responses and efficient use of trajectory data.

Further examples may relate to properties of the resulting closed-loop behavior. For instance, certain EIRL processes may provide assurances for convergence or policy stability in continuous-time settings. Illustrations of these concepts may be demonstrated through challenging applications such as control of unstable or nonminimum-phase aerospace systems, including hypersonic vehicles.

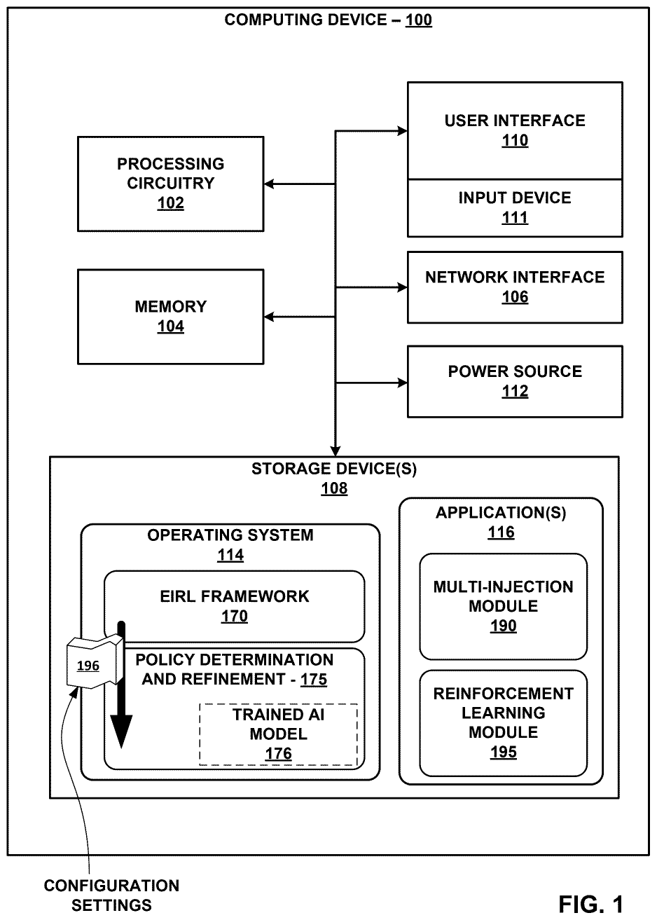

FIG. 1 is a block diagram illustrating further details of one example of computing device 100, in accordance with aspects of this disclosure. FIG. 1 illustrates only one particular example of computing device 100, and many other examples may be used in other instances.

As shown in FIG. 1, computing device 100 includes processing circuitry 102, memory 104, a network interface 106, one or more storage devices 108, user interface 110, input device 111, and power source 112. One or more storage devices 108 store operating system 114 and application(s) 116. Application(s) 116 include multi-injection module 190 and reinforcement learning module 195. One or more storage devices 108 also store EIRL framework 170 and policy determination and refinement 175, which is configured to produce trained AI model 176. Configuration settings 196 may be used to adjust or customize the operation of policy determination and refinement 175.

Operating system 114 may coordinate execution of EIRL framework 170, multi-injection module 190, and reinforcement learning module 195. EIRL framework 170 may supply functionality used during policy determination and refinement 175. Multi-injection module 190 may apply multi-injection excitation to a continuous-time system. Reinforcement learning module 195 may obtain state-action trajectory data, train a model using reinforcement learning, and update a policy using an integral reinforcement learning process. Policy determination and refinement 175 may generate trained AI model 176, which may be stored within one or more storage devices 108. Configuration settings 196 may provide user-adjustable inputs for modifying how policy determination and refinement 175 generates or updates trained AI model 176.

In some examples, processing circuitry 102 implements functionality and process instructions for execution within computing device 100. For example, processing circuitry 102 may process instructions stored in memory 104 and instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memory, dynamic random-access memory, static random-access memory, and other forms of volatile memory. In some examples, memory 104 may be used to store program instructions for execution by processing circuitry 102. Memory 104, in one example, may be used by software or applications running on computing device 100, such as application(s) 116, to temporarily store data or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, flash memories, or electrically programmable and electrically erasable memories.

Computing device 100, in some examples, may also include network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver, or any other type of device that can send and receive information. Additional examples may include BLUETOOTH®, 3G, 4G, 5G, LTE, WI-FI®, or USB-based interfaces. In some examples, computing device 100 may use network interface 106 to wirelessly communicate with an external device such as a server, mobile phone, or other networked computing device.

Computing device 100 may also include user interface 110. User interface 110 may include one or more input devices 111, such as a touch-sensitive display. Input device 111, in some examples, may be configured to receive input from a user through tactile, electromagnetic, audio, or video feedback. Examples of input device 111 may include a mouse, keyboard, voice-responsive system, video camera, microphone, or any other type of device for detecting user input. In some examples, a touch-sensitive display may include a presence-sensitive screen.

User interface 110 may also include one or more output devices, such as a display screen of a computing device or a touch-sensitive display. One or more output devices, in some examples, may be configured to provide output to a user using tactile, audio, or video stimuli. Examples of output devices may include a display, sound card, graphics adapter, speaker, cathode ray tube monitor, liquid crystal display, or any other device capable of generating output understandable to humans or machines.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of application(s) 116 with hardware components of computing device 100.

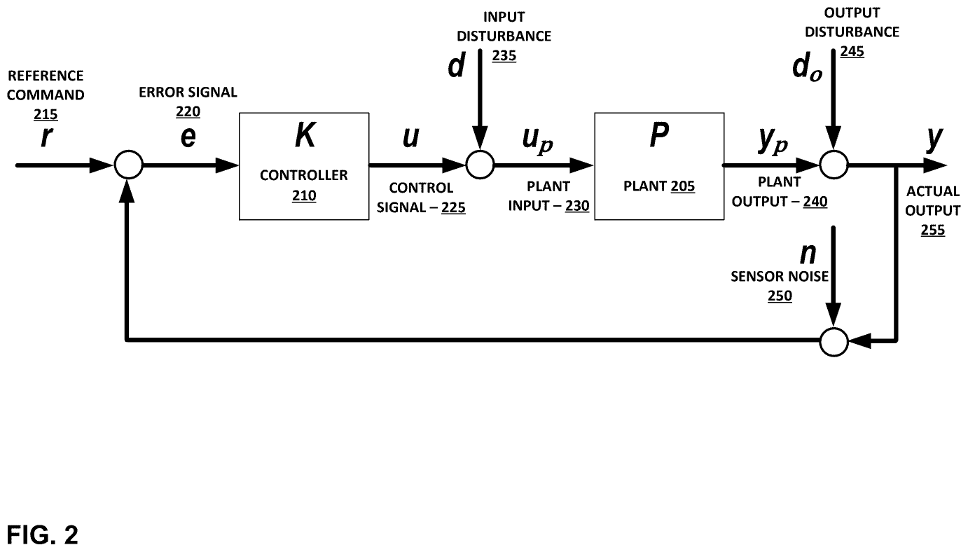

FIG. 2 illustrates an example negative feedback structure that may be utilized by excitable integral reinforcement learning (EIRL) framework 170, in accordance with aspects of this disclosure. In the example of FIG. 2, reference command 215 provides a signal r that feeds into a summing junction that generates error signal 220. Error signal 220 produces a signal e, which is provided to controller 210. Controller 210 generates control signal 225, shown as signal u, that is output to a second summing junction.

At the second summing junction, control signal 225 is combined with input disturbance 235, shown as signal d. The result of this combination is plant input 230, illustrated by signal uₚ, which is received by plant 205. Plant 205 outputs plant output 240, shown as signal yₚ, to a third summing junction.

At the third summing junction, plant output 240 is combined with output disturbance 245, represented by signal dₒ, to produce actual output 255, illustrated by signal y. Actual output 255 is provided both as an external system output and to a fourth summing junction located on the feedback path.

Sensor noise 250, shown as signal n, is combined with actual output 255 at the fourth summing junction. The result of this combination is fed back along the feedback pathway to the first summing junction to be combined with reference command 215 in generating error signal 220. Through this configuration, the structure of FIG. 2 may be used within EIRL framework 170 to characterize excitation, control policy behavior, and disturbance interactions.

Following the structural overview of FIG. 2, the operation of the excitable integral reinforcement learning processes can be further described with reference to the system formulation, value approximation structures, and learning updates. The following discussion provides technical background relevant to these processes.

The multi-injection excitation approach described herein provides a constructive technique for producing state information with persistent excitation properties by generating excitation through both the probing noise injection and the reference command pathway of FIG. 2. In practice, the frequencies and magnitudes of these injected signals are selected by analyzing the sensitivity characteristics of plant 205, including the peak regions of the sensitivity response and the complementary sensitivity map. By configuring the probing noise injection to place energy near these peak sensitivity regions and configuring the reference command pathway to preserve excitation in low-frequency regions where noise is attenuated by controller 210, the multi-injection excitation establishes a structured and repeatable method for generating state trajectories that satisfy persistent excitation conditions. This approach enables a skilled designer to determine appropriate excitation parameters without undue experimentation, since the sensitivity characteristics of plant 205 provide a systematic guide for selecting frequencies and amplitudes that result in persistently excited state information during online learning.

The updated policies generated by policy determination and refinement 175 and applied within controller 210 are used to actively regulate plant 205 in real time. In particular, controller 210 receives reference command 215 and actual output 255 within the feedback structure of FIG. 2 and produces control signal 225 that feeds into plant input 230 to actuate plant 205. During online operation, the refined operating policy is executed by controller 210 to adjust throttle commands, surface deflections, or other plant-control inputs in response to the measured state of the continuous-time system. By executing the updated policy within the closed-loop pathway of FIG. 2, the techniques described herein effect physical control of plant 205 rather than merely generating numerical policy parameters.

Modern approaches to optimal control and dynamic programming can be traced to foundational work by Richard E. Bellman in the 1960s, which formalized dynamic programming for sequential decision-making. Reinforcement learning emerged as a systematic method in the early 1980s and demonstrated the ability to address the curse of dimensionality inherent in dynamic programming. Within reinforcement learning, decision-making and control are often treated under approximate dynamic programming, which applies approximation and learning techniques to solve optimal control problems for both continuous-time and discrete-time dynamical systems.

Discrete-time reinforcement learning algorithms have demonstrated strong stability, convergence, and approximation properties. Studies utilizing policy iteration frameworks and value iteration frameworks have shown notable success across diverse applications, including energy-efficient data centers, ground robot position control, power system stability enhancement, industrial process control, helicopter stabilization, trajectory tracking, wastewater treatment, and wearable robotic systems that support stable locomotion.

Continuous-time reinforcement learning algorithms have achieved fewer practical successes. Although certain studies have expanded the theoretical foundation, challenges remain in synthesizing methods suitable for real-world continuous-time learning controllers. Several considerations contribute to this gap between theoretical analysis and practical implementation.

One consideration concerns numerical stability and scalability. Analyses of approximate dynamic programming techniques for continuous-time reinforcement learning indicate difficulty in achieving numerically stable learning behavior, particularly in the absence of closed-form optimal value functions. While theoretical demonstrations exist for simpler settings, guarantees of learning convergence without prior knowledge of the optimal solution remain unresolved.

Another consideration relates to algorithmic complexity. In many cases, the complexity of continuous-time learning algorithms makes constructive policy synthesis challenging. Few demonstrations provide procedures for deriving usable control policies, and further refinement may assist in broader application within control engineering contexts.

Current approximate dynamic programming techniques often rely on system states exhibiting persistently exciting behavior, meaning that, in response to sufficiently exciting inputs, system states may be used in system identification to support parameter learning. However, existing approaches do not provide constructive techniques for testing or achieving persistent excitation. In many continuous-time reinforcement learning implementations, probing noise may be introduced at a plant input to encourage persistently exciting trajectories. Introducing such probing noise can create tension with classical control approaches that suppress plant-input disturbances. Managing this tension may be relevant when reinforcement learning techniques depend on persistently exciting data.

Some prior techniques using deep continuous-time reinforcement learning have begun to explore controller synthesis, but these efforts remain in early stages. Function approximation applied to the Hamilton-Jacobi-Bellman equation has been investigated with limited success. Other studies have explored data-driven Q-learning interpretations of Kleinman's algorithm that generally apply to linear systems. Additional approaches have used policy iteration methods to solve the Hamilton-Jacobi-Bellman equation, although such techniques often rely on stringent assumptions. Semi-discrete Hamilton-Jacobi-Bellman formulations enable Q-learning using discrete-time data without explicitly discretizing system dynamics. Although promising, these techniques may be difficult to scale and can be sensitive to hyperparameter choices. Model-based optimal control techniques have also been explored for cart-pole and pendulum systems, though such techniques can be limited by state-distribution mismatches and difficulty scaling to higher-dimensional settings.

Other work has explored continuous-time reinforcement learning for general nonlinear, nonaffine dynamics, though only a limited number of results currently exist. One approach utilizes Bayesian neural ordinary differential equation models to infer state derivatives from irregular or noisy measurements, and reinforcement learning processes constructed around such inferred dynamics operate in an open-loop manner, which may limit applicability. Other studies have used neural ordinary differential equation models as feedback policies, but these approaches are generally restricted to fixed initial and final conditions and rely on known nonlinear dynamics for numerical state propagation. These methods represent initial progress toward handling general nonlinear dynamics, though further development may be useful for addressing more complex continuous-time reinforcement learning problems.

Subsequent approximate dynamic programming-based continuous-time reinforcement learning research builds upon earlier developments, and combining these ideas may support broader applicability. However, earlier continuous-time reinforcement learning analyses may not fully address certain performance considerations, and numerical evaluations may support further refinement.

To illustrate improved continuous-time reinforcement learning performance, experiments utilizing EIRL framework 170 are applied to an unstable, nonminimum-phase hypersonic vehicle example. Prior reinforcement learning-based control techniques have been applied to hypersonic vehicles, though these approaches exhibit limitations when considered for real-world flight-control applications. For instance, some earlier methods use a combined reinforcement learning and observer-based attitude-control structure, but the associated hypersonic vehicle model represents a simplified Stengel-style model that omits Mach-dependent aerodynamic variations. Neural control and adaptive critic design approaches also rely on this simplified model, which may limit practical applicability.

Stability analyses for such prior approaches commonly impose bounded approximation and tracking error conditions and require multiple inequality constraints to hold along closed-loop trajectories. No constructive technique has been offered for ensuring that these inequalities are satisfied, which may limit real-world implementation. Other adaptive critic design methods, including backstepping-based neural structures, feedback-linearization approaches, and sliding-mode designs, make use of partial derivative information from the underlying system dynamics. Reliance on such information may restrict applicability in learning contexts and may increase sensitivity to model uncertainty. Feedback linearization performs inversion of nonlinear dynamics and is also referred to as nonlinear dynamic inversion.

EIRL framework 170 introduces a designer-centric structure configured to support improved learning behavior. The multi-injection mode aligns excitation and exploration with input-output considerations. To support excitation, the multi-injection structure permits introducing continuous-time reinforcement learning probing noise together with a reference command excitation, which may promote persistently exciting behavior from an input-output perspective.

For systems that exhibit a physically motivated decomposition into separate dynamical loops, the decentralization capabilities of EIRL framework 170 divide the optimal control problem into multiple lower-dimensional subproblems, which may reduce numerical complexity and dimensionality.

The multi-injection capabilities of EIRL framework 170 remain general in their formulation and may be applicable to a wide range of approximate dynamic programming-based reinforcement learning control methods where persistent excitation is relevant. Many real-world applications exhibit natural dynamical partitions that support decentralization. For example, the longitudinal dynamics of certain hypersonic vehicle models separate into a translational or velocity loop and a rotational or flight path-angle loop. This translational and rotational decomposition has been used in classical hypersonic vehicle control approaches and may be applicable in aviation systems more broadly.

In robotics, Euler-Lagrange mechanical models often partition states according to degrees of freedom. For example, ground robot dynamics decompose into a translational speed loop and a rotational steering loop. Helicopter dynamics partition across three translational and three rotational axes, and unmanned aerial vehicle dynamics may exhibit similar structural partitioning.

Through these features, EIRL framework 170 supports a continuous-time reinforcement learning design that incorporates multi-injection capabilities and decentralization to enhance excitation and exploration. EIRL framework 170 provides decentralized excitable integral reinforcement learning algorithms that have been demonstrated as effective in numerical stability, training time, data efficiency, and generalization within a hypersonic vehicle example. When a physically meaningful dynamical decomposition exists, the decentralized variant of EIRL framework 170 may support improved learning efficiency.

Using classical control insights, theoretical analyses describe convergence behavior, solution optimality, and closed-loop stability for algorithms applied using EIRL framework 170.

The following discussion introduces a system formulation that may be used to describe the continuous-time dynamics, cost structure, and learning updates considered within EIRL framework 170.

System: Analysis for EIRL framework 170 applies the affine nonlinear system approach utilized by other continuous-time reinforcement learning (CT-RL) techniques, such as in deep reinforcement learning (RL) and adaptive dynamic programming (ADP) reinforcement learning methodologies.

The system of EIRL framework 170 is represented as Equation 1, set forth below, as Text use follows:

$$\dot{x} = f ( x ) + g ( x ) u ;$$

where x∈ [symbol] ⁿ is the state vector, where u∈ [symbol] ^{m} is the control vector, and where both f: [symbol] ⁿ→ [symbol] ⁿ, and g: [symbol] ⁿ→ [symbol] ⁿ× [symbol] ^{n×m} are functions assumed to be known. This formulation may utilize assumptions that f and g are Lipschitz continuous on a compact set Ω∪ [symbol] ⁿ that includes the origin and that f(0)=0.

The quadratic cost function may be expressed as Equation 2, set forth below:

$$J ( {x}_{0} ) = {\int }_{0}^{∞} ( {x}^{⊤} Q x + {u}^{⊤} R u ) d τ ;$$

where Q∈ [symbol] ^{n×n}, Q=Q^{T}≥0 and R∈ [symbol] ^{m×m}, R=R^{T}>0 serve as the state and control penalty matrices, respectively.

Kleinman's Algorithm for Linear Systems: This analysis incorporates successive approximation concepts from Kleinman's algorithm, alongside state-action data pairs (x,u) from the nonlinear system Equation (1), to enable efficient nonlinear excitable integral reinforcement learning (EIRL). Kleinman's algorithm, in its classical form, applies to the linear time-invariant system according to Equation 3, set forth below, as follows:

$$\dot{x} = A x + B u ;$$

where A∈ [symbol] ^{n×n} and B∈ [symbol] ^{n×m}.

$$( {Q}^{\frac{1}{2}} , A )$$

Here, the assumption is made that the pair (A, B) is stabilizable and that (Q, A) is detectable. Kleinman's algorithm iteratively solves for the optimal linear quadratic regulator (LQR) control K*=R⁻¹B^{T}P* associated with the quadruple (A, B, Q, R), where P*∈ [symbol] ^{n×n}, P*=P*^{T}>0 represents the solution to the Riccati equation. Assuming an initial policy K₀∈ [symbol] ^{m×n} such that A−BK₀ is Hurwitz, for each iteration i=0, 1, . . . , let

$${P}_{i} ∈ {ℝ}^{n \times n} , {P}_{i} = {P}_{i}^{⊤} > 0$$

be the symmetric positive definite solution of the algebraic Lyapunov equation (ALE) according to Equation 4, set forth below, as follows:

$${( A - B {K}_{i} )}^{⊤} {P}_{i} + {P}_{i} ( A - B {K}_{i} ) + {K}_{i}^{⊤} R {K}_{i} + Q = 0 .$$

After solving the ALE for Pᵢ in Equation (4), the policy Kᵢ₊₁∈ [symbol] ^{m×n} is updated recursively according to Equation 5, set forth below, as follows:

$${K}_{i + 1} = {R}^{- 1} {B}^{⊤} {P}_{i} .$$

### Relevant Operators for Learning:

Definition 1: For n∈ [symbol] , let Equation 6, set forth below, define:

$$\underline{n} {=}^{Δ} \frac{n ( n + 1 )}{2} .$$

In this context, Equation 6 defines a regression dimension value denoted as n, which represents the dimension of the vector space of symmetric n×n matrices utilized within the learning operators. The term n equals n(n+1)/2 and specifies the length of the vectors generated by the mapping defined in Equation 7. This regression dimension determines the size of the critic-network weight vectors and the dimensionality of the learning matrices that appear in the least-squares updates used throughout the integral reinforcement learning and decentralized integral reinforcement learning formulations.

Define the maps v: [symbol] ^{n×n}→ [symbol] ⁿ, and [symbol] : [symbol] ⁿ× [symbol] ⁿ→ [symbol] ⁿ according to Equation 7, set forth below, as follows:

$$v ( P ) = {[ {p}_{1 , 1} , 2 {p}_{1 , 2} , … , 2 {p}_{1 , n} , {p}_{2 , 2} , 2 {p}_{2 , 3} , … , 2 {p}_{n - 1 , n} , {p}_{n , n} ]}^{T} ;$$

and further according to Equation 8, set forth below, as follows:

$$B ( x , y ) = {\frac{1}{2} [ 2 {x}_{1} {y}_{1} , {x}_{1} {y}_{2} + {x}_{2} {y}_{1} , … , {x}_{1} {y}_{n} + {x}_{n} {y}_{1} , 2 {x}_{2} {y}_{2} , {x}_{2} {y}_{3} + {x}_{3} {y}_{2} , … , {x}_{n - 1} {y}_{n} + {x}_{n} {y}_{n - 1} , 2 {x}_{n} {y}_{n} ]}^{T} .$$

Define W∈ [symbol] ^{n×n}^{²} as the matrix that satisfies the identity according to Equation 9, set forth below, as follows:

$$ℬ ( x , y ) = W ( x ⊗ y ) ∀ x , y ∈ {ℝ}^{n}$$

where ⊗ denotes the Kronecker product. For l∈ [symbol] and a strictly increasing sequence

$${\{ {t}_{k} \}}_{k = 0}^{l} ,$$

whenever x, y: [t₀, tₗ]→ [symbol] ⁿ, define the matrix δ_{xy}∈ [symbol] ^{l×n} according to Equation 10, set forth below, as follows:

$${δ}_{xy} = [ \begin{matrix}{β}^{T} ( x ( {t}_{1} ) + y ( {t}_{0} ) , x ( {t}_{1} ) - y ( {t}_{0} ) ) \\ {β}^{T} ( x ( {t}_{2} ) + y ( {t}_{1} ) , x ( {t}_{2} ) - y ( {t}_{1} ) ) \\ ⋮ \\ {β}^{T} ( x ( {t}_{l} ) + y ( {t}_{l - 1} ) , x ( {t}_{l} ) - y ( {t}_{l - 1} ) )\end{matrix} ] .$$

Whenever x, y are square-integrable, define l [symbol] _{(x,y)}∈ [symbol] ^{l×n} according to Equation 11, set forth below, as follows:

$${I}_{β ( x , y )} = [ \begin{matrix}{\int }_{{t}_{0}}^{{t}_{1}} {β}^{T} ( x , y ) d τ \\ {\int }_{{t}_{1}}^{{t}_{2}} {β}^{T} ( x , y ) d τ \\ ⋮ \\ {\int }_{{t}_{l - 1}}^{{t}_{l}} {β}^{T} ( x , y ) d τ\end{matrix} ] .$$

Proposition 1: The operators v of Equation (7), B of Equation (8), and matrix W of Equation (9) satisfy the following: v is a linear surjection whose kernel is the subspace of strictly lower-triangular matrices. Thus, the restriction of v to the symmetric matrices is a linear isomorphism. The term B is a symmetric bilinear form. Whenever P∈ [symbol] ^{n×n}, P=P^{T}, the following holds according to Equation 12, set forth below, as follows:

$${ℬ}^{T} ( x , y ) v ( P ) = {x}^{T} P y ∀ x , y ∈ {ℝ}^{n} .$$

The term ∥W∥=1, and the rows of W are nonzero and pairwise orthogonal. In particular, W has a right inverse, denoted

$${W}_{r}^{- 1} ∈ {ℝ}^{{n}^{2} \times \underline{n}}$$

satisfying the identity according to Equation 13, set forth below, as follows:

$$x ⊗ x = {W}_{r}^{- 1} ℬ ( x , x ) ∀ x ∈ {ℝ}^{n} .$$

### Algorithms and Training:

Leveraging Kleinman's structure, excitable integral reinforcement learning (EIRL) uses state-action trajectory data (x, u) to iteratively solve for the optimal policy of the nonlinear system of Equation (1). Notably, both EIRL and decentralized EIRL (dEIRL) can be implemented with single-injection (SI) and multiple-injection (MI) modes. Consequently, variants of EIRL framework 170 utilize a suite of four continuous-time reinforcement learning (CT-RL) algorithms.

Single-Injection and Multiple-Injection: With reference to the architecture of FIG. 2, a standard negative feedback structure is depicted having a controller 210 represented by the term K and a plant 205 represented by the term P, where each may be either linear or nonlinear. In single-injection, a probing noise d(t)∈ [symbol] ^{m} is injected at the plant 205 input. This is the typical method of applying probing noise in CT-RL algorithms. In the multiple-injection case, a reference command r(t)∈ [symbol] ^{m} may optionally be injected to influence excitation characteristics.

Critic Network Structure: The critic neural network (NN) is given by V(x)= [symbol] ^{T}(x,x)v(Pᵢ), where v(Pᵢ)∈ [symbol] ⁿ is the weight vector yielded from the EIRL learning of Equation (18), and the basis consists of the monomials of degree two [symbol] (x,x)∈ [symbol] ⁿ of Equation (8). Applying the identity of Equation (12) yields V(x)= [symbol] ^{T}(x,x)v(Pᵢ)=x^{T}Pᵢx, the same quadratic approximation form of Kleinman's algorithm.

Policy Structure: Once the value function approximator V(x) has been solved, a corresponding sequence of learning policies of the form u(x)=−Kᵢx, as depicted by FIG. 2 is constructed. These policies Kᵢ are generated from the critic network weights v(Pᵢ) of Equation (18) via the nonlinear EIRL learning procedure described below.

Single-Injection EIRL: Given an iteration i≥0, the method of integral reinforcement is used to construct a learning update for the next iteration policy u(x)=−Kᵢ₊₁x∈ [symbol] ^{m}. Let t₀<t₁ be given. The critic network approximates the integral cost J of Equation (2), implying that along environment trajectories, the following holds according to Equation 14, set forth below, as follows:

$$V ( x ( {t}_{0} ) ) - V ( x ( {t}_{1} ) ) = {\int }_{{t}_{0}}^{{t}_{1}} {x}^{T} Q x + {u}^{T} Rud τ .$$

The right-hand side of Equation (14), called the integral reinforcement signal, requires only state-action data (x, u) from the nonlinear system of Equation (1). Equation (14) is satisfied when V=J. The learning objective is to minimize the residual network approximation error of Equation (14). To recast Equation (14) in a form suitable for regression, the terms in of Equation (1) are rearranged according to Equation 15, set forth below, as follows:

$$\dot{x} = w ( x ) + g ( x ) u + {A}_{i} x + B {K}_{i} x$$

$$w ( x ) {=}^{Δ} f ( x ) - A x , {A}_{i} {=}^{Δ} A - B {K}_{i} .$$

Here, the drift term w(x)≙f(x)−Ax∈ [symbol] ⁿ may capture system nonlinearities, dynamical coupling, and possible model uncertainties, while A and B are the known nominal linearization terms of f and g of Equation (1). It is emphasized that Equation (15) corresponds to the original nonlinear dynamics of Equation (1). Since Equation (15) contains the current-iterate policy Kᵢ, it may be used to solve for the next-iterate policy Kᵢ₊₁ when combined with the integral reinforcement of Equation (14) as follows. The value function V is differentiated along system trajectories, yielding:

$$V ( x ( {t}_{1} ) ) - V ( x ( {t}_{0} ) ) = {\int }_{{t}_{0}}^{{t}_{1}} ( d / ( d τ ) ) \{ V ( x ) \} d τ .$$

Along the solutions of the nonlinear system of Equation (1), this is defined according to Equation 16, set forth below, as follows:

$$V ( x ( {t}_{1} ) ) - V ( x ( {t}_{0} ) ) = {x}^{T} ( {t}_{1} ) {P}_{i} x ( {t}_{1} ) - {x}^{T} ( {t}_{0} ) {P}_{i} x ( {t}_{0} ) = {\int }_{{t}_{0}}^{{t}_{1}} [ 2 {( w + g u + B {K}_{i} x )}^{T} {P}_{i} x + {x}^{T} ( {A}_{i}^{T} {P}_{i} + {P}_{i} {A}_{i} ) x ] d τ .$$

Applying Equation (12) and rearranging terms, Equation (16) becomes Equation 17, set forth below, as follows:

$${[ - 2 {\int }_{{t}_{0}}^{{t}_{1}} ℬ ( w ( x ) + g ( x ) u + {BK}_{i} x , x ) d τ + ℬ ( x ( {t}_{1} ) + x ( {t}_{0} ) , x ( {t}_{1} ) - x ( {t}_{0} ) ) ]}^{T} v ( {P}_{i} ) = {[ {\int }_{{t}_{0}}^{{t}_{1}} ℬ ( x , x ) d τ ]}^{T} v ( {A}_{i}^{T} {P}_{i} + {P}_{i} {A}_{i} ) = - {[ {\int }_{{t}_{0}}^{{t}_{1}} ℬ ( x , x ) d τ ]}^{T} v ( Q + {K}_{i}^{T} R {K}_{i} )$$

where the second equality in Equation (17) follows from Pᵢ=Pᵢ^{T}>0, which satisfies the algebraic Lyapunov equation (ALE) of Equation (4). The integral reinforcement of Equation (17) may be expressed in the required form. The terms in brackets

$${[ - 2 {\int }_{{t}_{0}} {}^{{t}_{1}} B ( w ( x ) + g ( x ) u + {BK}_{i} x , x ) d τ + B ( x ( {t}_{1} ) + x ( {t}_{0} ) , x ( {t}_{1} ) - x ( {t}_{0} ) ) ]}^{T} v ( {P}_{i} )$$

contain environment trajectory integral and difference data and may form a single row of the learning matrix Θ of Equation (19), multiplied on the right by the critic weight vector v(Pᵢ)∈ [symbol] ⁿ. Meanwhile, the term in

$$v ( Q + {K}_{i}^{T} R {K}_{i} )$$

utilizes only integral state data x and may form a single element of the learning vector Ξᵢ of Equation (20).

Learning Update Construction: The resulting learning update is constructed from l∈N trajectory samples using the integral reinforcement of Equation (17), which may include use of a single trajectory sample. Given a sequence of sample instants

$${\{ {t}_{k} \}}_{k = 0}^{l}$$

and probing noise injection d, the nonlinear system of Equation (1) is excited with d under an initial stabilizing policy K₀ while collecting state-action data

$${\{ ( x ( {t}_{k} ) , u ( {t}_{k} ) ) \}}_{k = 0}^{l} .$$

By applying the identities of Equation (9) and Equation (13) to the integral reinforcement of Equation (17) at the sample instants

$${\{ {t}_{k} \}}_{k = 0}^{l} ,$$

the learning update may be derived according to Equation (18), as follows:

$${Θ}_{i} v ( {P}_{i} ) = {Ξ}_{i} ;$$

where the learning matrices Θᵢ∈ [symbol] ^{l×n}, and Ξᵢ∈ [symbol] ^{l} a are determined by Equation (19) and Equation (20). Equation (19) is set forth below, as follows:

$${Θ}_{i} = - 2 [ {I}_{ℬ ( x , w + g u )} + {I}_{ℬ ( x , x )} {W}_{i}^{T} ] + {δ}_{x} c ;$$

and
Equation (20) is set forth below, as follows:

$${Ξ}_{i} = - {I}_{ℬ ( x , x )} v ( Q + {K}_{i}^{T} {RK}_{i} ) .$$

Here,

$${W}_{i} {=}^{Δ} W ( {I}_{n} ⊗ {BK}_{i} ) {W}_{r}^{- 1} ,$$

where W and

$${W}_{r}^{- 1}$$

are described in Equation (9) and Equation (13), respectively. The terms I [symbol] _{(x,·)}, δₓₓ∈ [symbol] ^{l×n} of Equation 11 act as “storage” matrices containing integral data

$${I}_{ℬ ( x , \cdot )} ← {\int }_{{t}_{k - 1}}^{{t}_{k}} x d τ$$

and difference data δₓₓ←x(tₖ)−x(tₖ₋₁) between trajectory samples as they appear in the integral reinforcement of Equation (17).

After solving for the critic weights v(Pᵢ) of Equation (18), the policy Kᵢ₊₁ is updated using Equation (5), and this process is repeated.

Remark 1—Probing Noise and Data Reuse in EIRL vs. Original IRL Formulation: EIRL enables learning in controller design via appropriate probing noise injection, which is not included in the original IRL algorithm. The absence of probing noise in the original IRL formulation creates a practical challenge, as it makes proper system excitation difficult to achieve. Additionally, the algebra derived for the term

$${I}_{ℬ ( x , x )} {W}_{i}^{T} = {I}_{ℬ ( x , {BK}_{i} x )} ∈ {ℝ}^{l \times \underline{n}}$$

of Equation (19), enabled by Kleinman's structure, may allow reuse of state-trajectory data collected under the initial policy K₀ to support generating the sequence

$${\{ {K}_{i} \}}_{i = 1}^{∞} .$$

This differs from the original IRL formulation, which is typically configured such that state-action data are generated under the stabilizing policy Kᵢ before updating to Kᵢ₊₁.

Remark 2—EIRL Algorithm vs. Subsequent IRL Formulation: EIRL provides a number of practical capabilities. EIRL as implemented by EIRL framework 170 accommodates nonlinear systems, while formulations used in prior known techniques have generally been applied to linear systems. Furthermore, comparing the learning regression of Equation (18) with prior known techniques, it becomes evident that Equation (18) is lower-dimensional (n for EIRL versus n+mn in prior known techniques). This reduction in dimensionality occurs because the controller Kᵢ₊₁∈ [symbol] ^{m×n} is no longer part of the regression vector of Equation (18). Consequently, knowledge of the system input dynamics g (and thus B) is required for Equation (18). The tradeoff of reduced dimensionality in exchange for system knowledge may support control solutions that earlier methods did not readily address, which had limitations even for low-order academic examples (e.g., (n=2, m=1)).

Furthermore, by leveraging the structure of Kleinman's algorithm, EIRL framework 170 converges to the optimal linear-quadratic (LQ) control law. As a result, the policies generated through the disclosed learning processes inherit the substantial stability and performance robustness margins associated with classical LQ control, properties that existing continuous-time reinforcement learning approaches often fail to guarantee. These inherited robustness margins render the disclosed techniques particularly suitable for mission-critical environments in which safety and predictability are paramount, including robotics, autonomous vehicle operation, and commercial or defense aerospace systems.

SI Decentralized EIRL: The single-loop variant of EIRL framework 170 can be generalized to a decentralized system with N≥1 loops. For illustration, consider N=2 loops; however, all results apply to N>2 loops according to Equation 21, set forth below, as follows:

$$[ \begin{matrix}{\dot{x}}_{1} \\ {\dot{x}}_{2}\end{matrix} ] = [ \begin{matrix}{f}_{1} ( x ) \\ {f}_{2} ( x )\end{matrix} ] + [ \begin{matrix}{g}_{11} ( x ) & {g}_{12} ( x ) \\ {g}_{21} ( x ) & {g}_{22} ( x )\end{matrix} ] [ \begin{matrix}{u}_{1} \\ {u}_{2}\end{matrix} ] .$$

No assumptions are made regarding dynamic coupling between the loops, meaning the loops may be fully coupled.

Let xⱼ∈ [symbol] ⁿ^{ⱼ}, uⱼ∈ [symbol] ^{m}^{ⱼ}(j=1, . . . , N) with

$${\sum }_{j = 1}^{N} {n}_{j} = n and {\sum }_{j = 1}^{N} {m}_{j} = m .$$

For convenience, define gⱼ: [symbol] ⁿ→ [symbol] ⁿ^{ⱼ}^{×m},gⱼ(x)=[gⱼ₁(x) . . . g_{jN}(x)]. Consider a block-diagonal Q-R cost structure according to Equation 22, set forth below, as follows:

$$Q = [ \begin{matrix}{Q}_{1} & 0 \\ 0 & {Q}_{2}\end{matrix} ] , R = [ \begin{matrix}{R}_{1} & 0 \\ 0 & {R}_{2}\end{matrix} ] ;$$

where

$${Q}_{j} ∈ {ℝ}^{{n}_{j} \times {n}_{j}} , {Q}_{j} = {Q}_{j}^{T} \geq 0 , and {R}_{j} ∈ {ℝ}^{{m}_{j} \times {m}_{j}} , {R}_{j} = {R}_{j}^{T} > 0 ( j = 1 , … , N ) .$$

Kleinman's algorithm can be applied to a decentralized linear system described by (A, B) according to Equation 23, set forth below, as follows:

$$[ \begin{matrix}{\dot{x}}_{1} \\ {\dot{x}}_{2}\end{matrix} ] = [ \begin{matrix}{A}_{11} & {A}_{12} \\ {A}_{21} & {A}_{22}\end{matrix} ] [ \begin{matrix}{x}_{1} \\ {x}_{2}\end{matrix} ] + [ \begin{matrix}{B}_{11} & {B}_{12} \\ {B}_{21} & {B}_{22}\end{matrix} ] [ \begin{matrix}{u}_{1} \\ {u}_{2}\end{matrix} ] ;$$

where Bⱼ=[Bⱼ₁ . . . B_{jN}]∈ [symbol] ⁿ^{ⱼ}^{×m} is analogously defined.

This results in sequences

$${\{ {P}_{i , j} \}}_{i = 0}^{∞} in {ℝ}^{{n}_{j} \times {n}_{j}} and {\{ {K}_{i , j} \}}_{i = 1}^{∞} in {ℝ}^{{m}_{j} \times {n}_{j}}$$

derived from the ALE according to Equation 24, set forth below, as follows:

$${( {A}_{jj} - {B}_{jj} {K}_{i , j} )}^{⊤} {P}_{i , j} + {P}_{i , j} ( {A}_{jj} - {B}_{jj} {K}_{i , j} ) + {K}_{i , j}^{⊤} {R}_{j} {K}_{i , j} + {Q}_{j} = 0.$$

Critic Network for dEIRL: Analogously, the critic network for dEIRL is expressed as

$$V ( x ) = {\sum }_{j = 1}^{N} {V}_{j} ( {x}_{j} ) ,$$

where Vⱼ(xⱼ)= [symbol] ^{T}(xⱼ,xⱼ)v(P_{i,j}) and now v(P_{i,j})∈ [symbol] ⁿ^{ⱼ} is obtained from dEIRL learning as described in Equation (26).

Decentralized EIRL: Consider any loop 1≤j≤N. Similar to Equation (15), rearranging terms in Equation (21) results in Equation 25, set forth below, as follows:

$${\dot{x}}_{j} = {w}_{j} ( x ) + {g}_{j} ( x ) u + {A}_{i , j} {x}_{j} + {B}_{jj} {K}_{i , j} {x}_{j} .$$

$${w}_{j} ( x ) {=}^{Δ} {f}_{j} ( x ) - {A}_{jj} {x}_{j} , {A}_{i , j} {=}^{Δ} {A}_{jj} - {B}_{jj} {K}_{i , j} .$$

Given a designer-selected sample count lⱼ∈ [symbol] , sample instants

$${\{ {t}_{k , j} \}}_{k = 0}^{{i}_{j}} ,$$

and loop probing noise excitation dⱼ, a derivation leads to the decentralized learning update given by Equation 26, set forth below, as follows:

$${Θ}_{i , j} v ( {P}_{i , j} ) = {Ξ}_{i , j} ;$$

where the learning matrices Θ_{i,j}∈ [symbol] ^{l}^{ⱼ}^{×n}^{ⱼ}, Ξ_{i,j}∈ [symbol] ^{l}^{ⱼ} are provided according to Equation 27, set forth below, as follows:

$${Θ}_{i , j} = - 2 [ {I}_{ℬ ( {x}_{j} , {w}_{j} + {g}_{j} u )} + {I}_{ℬ ( {x}_{j} , {x}_{j} )} {W}_{i , j}^{⊤} ] + {δ}_{{x}_{j} {x}_{j}} ;$$

and
according to Equation 28, set forth below, as follows:

$${Ξ}_{i , j} = - {I}_{ℬ ( {x}_{j} , {x}_{j} )} v ( {Q}_{j} + {K}_{i , j}^{⊤} {R}_{j} {K}_{i , j} ) ;$$

and where

$${W}_{i , j} {=}^{Δ} W ( {I}_{{n}_{j}} ⊗ {B}_{jj} {K}_{i , j} ) {W}_{r}^{- 1} .$$

After solving for the critic weights v(P_{i,j}) of Equation 26, the policy is updated analogously to Equation (5), according to Equation 29, set forth below, as follows:

$${K}_{i + 1 , j} = {R}_{j}^{- 1} {B}_{jj}^{⊤} {P}_{i , j} .$$

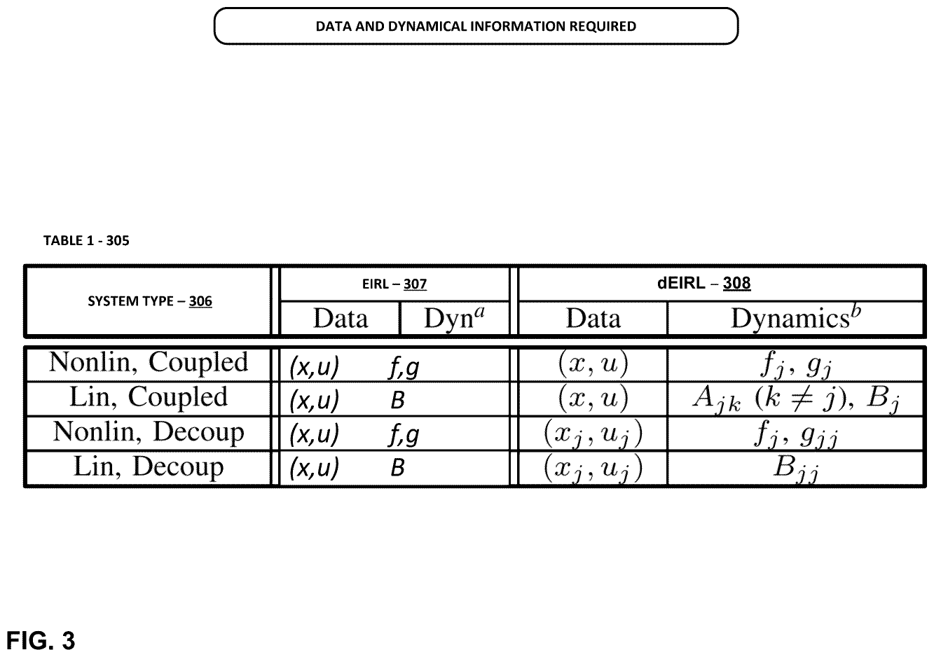

FIG. 3 illustrates Table 1 305, which summarizes state-action data requirements and corresponding dynamical information for multiple continuous-time system types under EIRL 307 and dEIRL 308, in accordance with aspects of this disclosure. Table 1 305 includes system type 306, EIRL 307, and dEIRL 308. System type 306 identifies nonlinear coupled systems, linear coupled systems, nonlinear decoupled systems, and linear decoupled systems. For each system classification in system type 306, EIRL 307 specifies data requirements and associated dynamical quantities, and dEIRL 308 specifies loop-specific data requirements and dynamical quantities when decentralization is applicable.

Within EIRL 307, the data column lists state-action trajectory pairs expressed as (x, u). The dynamical information column lists nonlinear drift and input maps f and g for nonlinear systems or linear input matrices B for linear systems. For nonlinear coupled systems and nonlinear decoupled systems in system type 306, EIRL 307 utilizes f and g defined in Equation 1 to characterize the system dynamics. For linear coupled systems and linear decoupled systems in system type 306, EIRL 307 utilizes B defined in Equation 3 to characterize the linear input dynamics.

Within dEIRL 308, the data column lists either (x, u) or decentralized loop-specific pairs (xⱼ, uⱼ). For nonlinear coupled systems and linear coupled systems in system type 306, dEIRL 308 uses (x, u). For nonlinear decoupled systems and linear decoupled systems in system type 306, dEIRL 308 uses (xⱼ, uⱼ), which corresponds to trajectory data associated with loop j. The dynamical information column for dEIRL 308 includes loop-specific nonlinear drift and input maps fⱼ and gⱼ from Equation 21, loop-specific coupling terms Aⱼₖ for k≠j from Equation 23, and loop-specific input matrices Bⱼ and Bⱼⱼ as defined in Equation 23. For nonlinear decoupled systems in system type 306, dEIRL 308 uses fⱼ and gⱼⱼ. For linear decoupled systems in system type 306, dEIRL 308 uses Bⱼⱼ.

Table 1 305 illustrates that EIRL 307 and dEIRL 308 both rely on state-action data but differ in how dynamical information is organized for centralized and decentralized learning updates. The relationships conveyed by Table 1 305 support comparison between centralized excitable integral reinforcement learning and decentralized excitable integral reinforcement learning within EIRL framework 170.

The definitions for f and g appear in Equation 1, and the definition for B appears in Equation 3. The definitions for fⱼ, gⱼ, gⱼⱼ, Aⱼₖ, Bⱼ, Bⱼⱼ appear in Equation 21 and Equation 23.

Remark 3 describes the nominal dynamical information required by EIRL and dEIRL. Table 1 305 summarizes the state-action data and dynamical quantities required to carry out EIRL and dEIRL in loop I≤j≤N. These physics-based learning processes may utilize a nominal model consisting of f and g, which yields a nominal linearization defined by A and B. The algorithms use state-action data (x, u) from the physical process to refine a control policy for the true nonlinear dynamics. When the system is linear, EIRL does not require knowledge of drift dynamics A. For dEIRL applied to linear systems represented by Equation 23, the drift term wⱼ(x) may be expressed as wⱼ(x)=Σ_{k≠j} Aⱼₖxₖ, meaning that Aⱼⱼ is not required and only off-diagonal terms Aⱼₖ need to be known.

For systems that are dynamically decoupled in the sense of Equation 21, the drift term satisfies fⱼ(x)=fⱼ(xⱼ) and the input term satisfies gⱼ(x)u=gⱼⱼ(x₁)u₁ for each loop 1≤j≤N. Under these conditions, all cross-coupling terms vanish, so that gⱼₖ(x)=0 and Aⱼₖ=0 for every k≠j. When this dynamical decoupling holds, the decentralized excitable integral reinforcement learning update of Equation 26 reduces to an algebraically decoupled form in which the learning matrices Θ_{i,j} and Ξ_{i,j} depend only on the loop-specific quantities x₁, u₁, fⱼ, and gⱼⱼ. Consequently, dEIRL may be executed using strictly loop-specific state-action data (xⱼ,uⱼ), and no cross-loop dynamical information is required.

Probing noise injection considerations relate to achieving persistent excitation for learning updates. Continuous-time reinforcement learning processes may require persistently exciting state-action trajectories. In many adaptive dynamic programming settings, probing noise d(t)∈ [symbol] ^{m} is applied at the input of the system defined in Equation 1. In machine-learning contexts, extensive exploration may achieve a similar effect through dense data collection. However, insufficiently designed probing signals may create practical challenges related to stability or numerical behavior. Returning to the closed-loop structure of FIG. 2, with plant 205 and controller 210 represented by P and K, respectively, the closed-loop map from plant input disturbance d to plant output y is represented by T_{d→y}, and the closed-loop map from reference command r to plant output y is represented by T_{r→y}. These maps may be used to analyze how probing noise and reference-command excitation influence persistent excitation within EIRL framework 170.

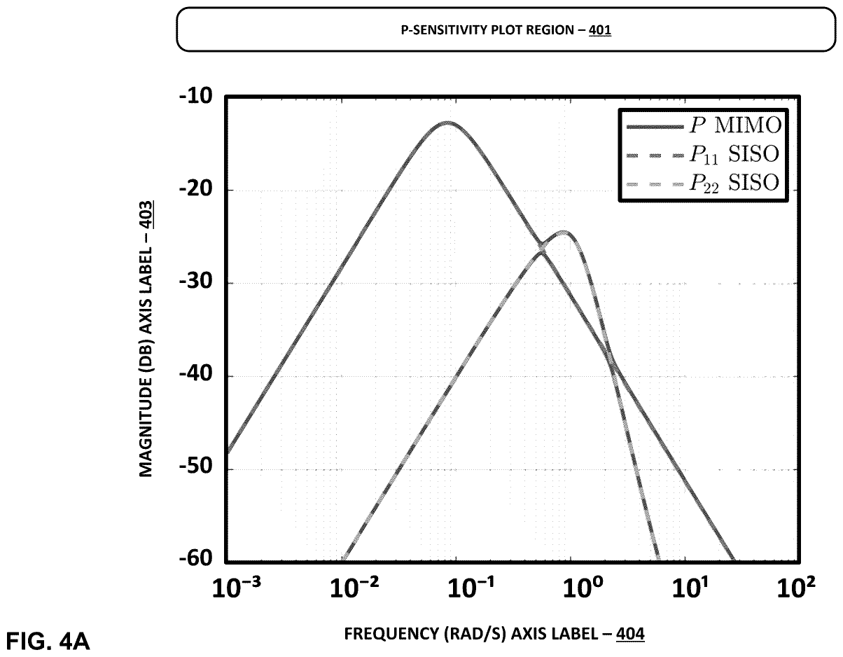

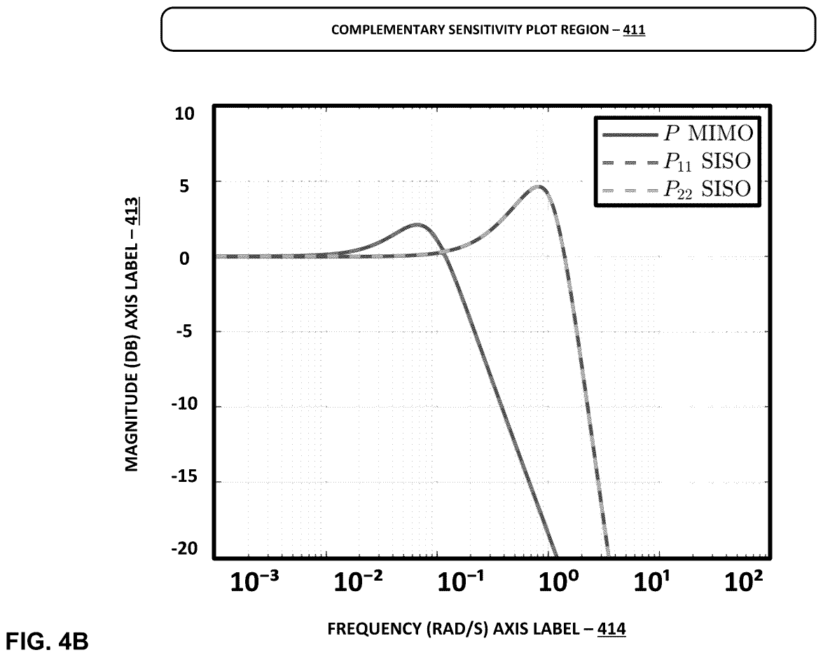

FIGS. 4A and 4B depict closed-loop frequency responses used to illustrate challenges associated with probing noise injection within excitable integral reinforcement learning processes, in accordance with aspects of this disclosure. In particular, FIG. 4A includes P-sensitivity plot region 401, which presents the closed-loop map from plant input disturbance d to system output y, represented by the P-sensitivity T_{d→y}. FIG. 4A further includes magnitude (dB) axis label 403 and frequency (rad/s) axis label 404. FIG. 4B includes complementary sensitivity plot region 411, which presents the closed-loop map from reference command r to system output y, represented by the complementary sensitivity T_{r→y}. FIG. 4B further includes magnitude (dB) axis label 413 and frequency (rad/s) axis label 414.

To illustrate typical input-output behavior under a hypersonic vehicle control design, FIGS. 4A and 4B show both the exact multiple-input, multiple-output (MIMO) frequency responses and single-input, single-output (SISO) approximations corresponding to the individual loops of the system. The frequency response associated with loop j=2 of the hypersonic vehicle, corresponding to the flight path angle output variable y, is represented by a dashed curve and is of particular interest due to its numerically challenging behavior. Because probing noise is injected at the input of plant 205 within the closed-loop structure of FIG. 2, the effective closed-loop map from probing noise d to output γ, is given by the P-sensitivity T_{d→y} illustrated within P-sensitivity plot region 401 of FIG. 4A.

Inspection of the SISO approximation of T_{d→y} in FIG. 4A indicates significant attenuation of probing noise across broad frequency ranges. For example, the best-case attenuation is approximately −25 dB, meaning that probing noise is reduced by a factor of approximately 20 near frequencies around ω≈1 rad/s. Moreover, probing noise components below approximately 10⁻¹ rad/s and above approximately 2.5 rad/s are attenuated by more than −40 dB, corresponding to a reduction by a factor of 100 or more. This analysis demonstrates that, for loop j=2, sufficient excitation through probing noise injection alone is difficult to achieve in practice when operating within the classical control structure depicted in FIG. 2.

These attenuation characteristics identify specific frequency regions where probing-noise excitation becomes ineffective for learning updates. Frequency components below approximately 0.1 rad/s and above approximately 2.5 rad/s are strongly rejected by the closed-loop sensitivity response associated with plant 205 and controller 210, resulting in attenuation magnitudes of at least −40 dB. Within these ranges, disturbance-input pathways suppress injected excitation by two orders of magnitude or more, preventing probing-noise injection from generating persistently exciting state trajectories suitable for regression. This behavior demonstrates that classical disturbance-rejection design goals can directly inhibit excitation in continuous-time reinforcement learning contexts, and it motivates the use of multi-injection excitation to introduce reference-command components that are not subject to the same low-frequency and high-frequency rejection.

This real-world example illustrates a broader distinction between reinforcement learning approaches and classical control principles. From a classical control perspective, the P-sensitivity response illustrated within P-sensitivity plot region 401 of FIG. 4A is favorable because strong input disturbance rejection is a desirable closed-loop property. However, from a reinforcement learning perspective, the same P-sensitivity response creates significant difficulty because strong attenuation of probing noise prevents the generation of persistently exciting state trajectories. As a result, the classical design goal of disturbance rejection conflicts with the reinforcement learning requirement for excitation. This motivates the introduction of multi-injection excitation capabilities within excitable integral reinforcement learning.

Multi-injection excitation may be constructed by combining probing-noise terms selected from the closed-loop P-sensitivity map T_{d→y}(jω) with reference-command excitation terms selected from the complementary sensitivity map T_{d→y}(jω). To enhance persistent excitation, dominant probing-noise frequencies ω₁ and ω₂ may be chosen to align with frequency regions where |T_{d→y}(jω)| is relatively large, such that attenuation of injected disturbances is minimized. Additional probing-noise components may be placed at frequencies where |T_{d→y}(jω)| does not exhibit excessive roll-off, thereby increasing sensitivity of the closed-loop system to the injected disturbance and supporting stronger excitation of the state trajectories. Complementarily, dominant frequencies for the reference command r(t) may be selected from ranges where |T_{r→y}(jω)| is near unity, permitting reference-command excitation to propagate through the closed loop with minimal attenuation. Under this construction, the resulting control input may be written in the form u=μ(x)+\tilde{d}, where \tilde{d}≙d+(μ(e,xᵣ)−μ(y,xᵣ)), with

$$x = {[ {y}^{⊤} , {x}_{r}^{⊤} ]}^{⊤}$$

representing a partition of the measured and remaining system states. When multi-injection is used with dynamic compensators, the compensator state e(t) may be simulated online to evaluate μ(e,xᵣ). Together, these design choices may enable excitation aligned with classical closed-loop characteristics while maintaining reinforcement-learning-compatible input structure.

Within excitable integral reinforcement learning and decentralized excitable integral reinforcement learning, the control input may be expressed in the form u=−Ke+d, where e represents the tracking error and K represents a compensator. The term Ke corresponds to the effect of the reference command injection, while d corresponds to probing noise. These two excitation sources provide independent adjustments for shaping the persistence of excitation properties of the state-action trajectories used for learning. Both deterministic reference signals and stochastic reference signals may be used, depending on designer preference. Because reference-command excitation operates through T_{r→y}, multi-injection excitation does not conflict with classical disturbance-rejection principles while providing improved excitation for learning updates.

If a continuous-time reinforcement learning algorithm requires an excitation of the form u=μ(x)+d, where μ is a stabilizing policy, multi-injection excitation can be incorporated without altering the theoretical structure of the algorithm. A subset of the system state x can be selected as measurement variables y suitable for reference injection. After indexing the state as

$$x = {[ {y}^{⊤} {x}_{r}^{⊤} ]}^{⊤}$$

with xᵣ of xᵣ∈ [symbol] ^{n-m} representing the remaining components, the resulting control input under reference injection may be written in the form μ(x)+\tilde{d}, which is utilized for execution.

Equation 30, is set forth below, as follows:

$$u = μ ( e , {x}_{r} ) + d = μ ( y , {x}_{r} ) + \tilde{d} ;$$

and

Equation 31, is set forth below, as follows:

$$\tilde{d} {=}^{Δ} d + ( μ ( e , {x}_{r} ) - μ ( y , {x}_{r} ) ) .$$

Because reinforcement learning algorithms permit freedom in the selection of probing noise signals, choosing d=\tilde{d} satisfies the required structure. In exchange for the improved excitation capability provided by multi-injection excitation, a modest increase in computational workload may occur when compensator K is dynamic, although this does not increase the dimensionality of the learning problem or impose additional model requirements.

Accordingly, FIGS. 4A and 4B illustrate how P-sensitivity plot region 401 and complementary sensitivity plot region 411 reveal complementary closed-loop behaviors that motivate the multi-injection design. The graphical relationships in magnitude (dB) axis label 403, frequency (rad/s) axis label 404, magnitude (dB) axis label 413, and frequency (rad/s) axis label 414 support an input-output interpretation of excitation properties used by excitable integral reinforcement learning processes.

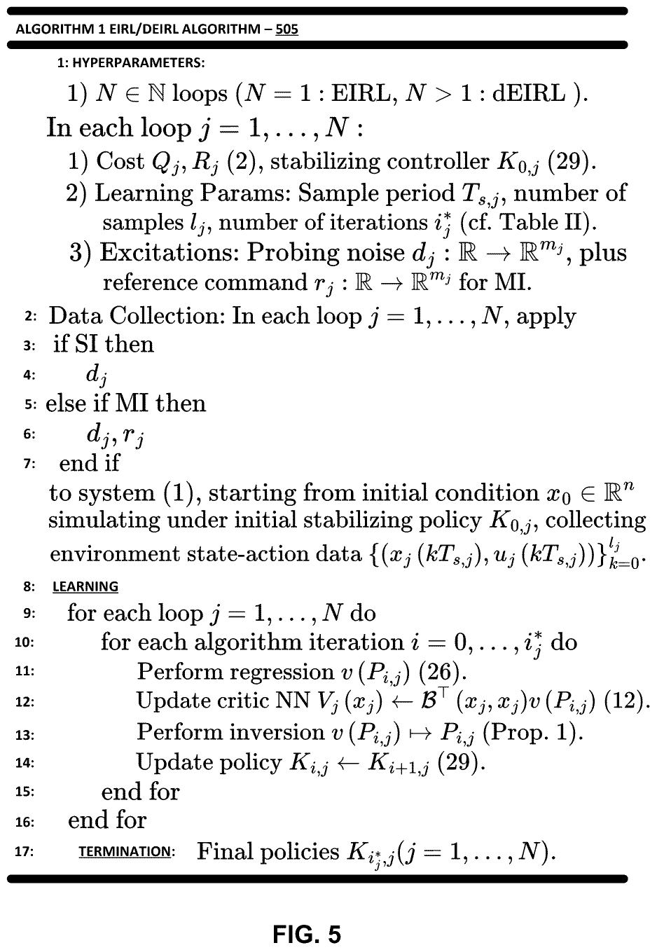

FIG. 5 depicts Algorithm 1, set forth at element 505, summarizing the EIRL and dEIRL execution procedure in both SI and MI modes, in accordance with aspects of the disclosure.

Summary of EIRL and dEIRL Execution Procedure: The execution procedure for EIRL and dEIRL is summarized in Algorithm 1, in both their single-injection and multi-injection modes.

Theoretical Results: Convergence and stability guarantees are proven for the methodologies of EIRL framework 170 as described herein. Throughout, the baseline dynamical assumptions outlined above are assumed to hold. The discussion begins with EIRL. Before moving to the main theoretical results, the following two lemmas are provided.

Lemma 1: Suppose that the controller Kᵢ∈ [symbol] ^{m×n} is stabilizing, and that the matrix Θᵢ∈ [symbol] ^{l×n} of Equation (19) has full column rank. Then

$${P}_{i} ∈ {ℝ}^{n \times n} , {P}_{i} = {P}_{i}^{⊤} > 0$$

is the unique positive definite solution to the ALE of Equation (4) if and only if Pᵢ satisfies the least-squares regression of Equation (18) at equality. In particular, the least-squares solution of the EIRL algorithm of Equation (18) yields the solution of the associated ALE of Equation (4).

Proof of Lemma 1: The forward direction is established in Equations (16) and Equations (17). Conversely, consider that v(P)∈ [symbol] ⁿ minimizes the least-squares regression in Equation (18). Since Θᵢ has full column rank, the solution v(P)∈ [symbol] ⁿ is unique. Furthermore, let

$${P}_{i} = {P}_{i}^{⊤} > 0$$

represent the unique positive definite solution to the ALE in Equation (4). It has been demonstrated that v(Pᵢ)∈ [symbol] ⁿ satisfies Equation (18) at equality. Consequently, v(P)=v(Pᵢ). As v, when restricted to the symmetric matrices, is a bijection (Proposition 1), this implies that P=Pᵢ is the solution to the ALE in Equation (4).

Lemma 2: Suppose that l∈ [symbol] and the sample instants

$${\{ {t}_{k} \}}_{k = 0}^{l}$$

are chosen such that the matrix [symbol] of Equation 11 has full column rank n. If Kᵢ is stabilizing, then the matrix Θᵢ∈ [symbol] ^{l×n} of Equation 18 has full column rank n.

Proof of Lemma 2: Suppose v(P)∈ [symbol] ⁿ is such that Θᵢv(P)=0. Then, the identity in Equation (12) and the first equality in Equation (17), which holds for any symmetric matrix, imply that Θᵢv(P)= [symbol] v(S), where S∈ [symbol] ^{n×n}, S=S^{T} is provided according to the supplementary equation, set forth below, as follows:

$$S = {A}_{i}^{⊤} P + {PA}_{i} .$$

The supplementary equation provided above represents an ALE, which, since S=S^{T} and Aᵢ=A−BKᵢ is Hurwitz, has the unique solution

$$P = {\int }_{0}^{∞} {e}^{{A}_{i}^{⊤} τ} ( - S ) {e}^{{A}_{i} τ} d τ .$$

Meanwhile, due to the full column rank of [symbol] the condition [symbol] v(S)=0 implies that v(S)=0, or S=0. Consequently, P=0, which means v(P)=0. Altogether, it has been demonstrated that Θᵢ has a trivial right null space, and thus, Θᵢ has full column rank.

Theorem 1—Convergence, Optimality, and Closed-Loop Stability of EIRL: Suppose that l∈ [symbol] and the sample instants

$${\{ {t}_{k} \}}_{k = 0}^{l}$$

are chosen such that the matrix [symbol] of Equation (11) has full column rank n. If K₀ is stabilizing, then the EIRL algorithm and Kleinman's algorithm are equivalent in the sense that the sequences

$${\{ {P}_{i} \}}_{i = 0}^{∞} and {\{ {K}_{i} \}}_{i = 1}^{∞}$$

produced by both are identical. Therefore, the convergence, optimality, and stability conclusions of Kleinman's algorithm provided below by Theorem A.1 hold for the EIRL algorithm with the choice of critic bases [symbol] (x,x) on the nonlinear system of Equation (1).

Proof: Follows by induction on i, after applying Lemmas 2 and 1.

### Classical Kleinman Algorithm Properties

Theorem A.1—Convergence, Optimality, Closed-Loop Stability of Kleinman's Algorithm: Let the assumptions above hold. The following results apply: The matrix A—BKᵢ is Hurwitz for all i≥0. The sequence P*≤Pᵢ₊₁≤Pᵢ holds for all i≥0. Finally,

$${lim}_{i \to ∞} {K}_{i} = {K}^{*} , {lim}_{i \to ∞} {P}_{i} = {P}^{*} .$$

Theorem 2—Convergence, Optimality, and Closed-Loop Stability of dEIRL: Suppose that for 1≤j≤N that lⱼ∈ [symbol] and the sample instants

$${\{ {t}_{k , j} \}}_{k = 0}^{{l}_{j}}$$

are chosen such that [symbol] of Equation (11) has full column rank nⱼ. If K_{0,j}, is stabilizing in loop j, then the dEIRL algorithm and Kleinman's algorithm are equivalent in that the sequences

$${\{ {P}_{i , j} \}}_{i = 0}^{∞} and {\{ {K}_{i , j} \}}_{i = 1}^{∞}$$

produced by both are identical. Thus, the convergence, optimality, and stability conclusions of Kleinman's algorithm (Theorem A.1 above) hold for the dEIRL algorithm with the choice of critic bases [symbol] (xⱼ,xⱼ) on the decentralized nonlinear system of Equation (21).

Remark 4—dEIRL Algorithm: Decentralized Learning, With or Without Dynamic Coupling: The dEIRL algorithm (via Theorem 2) guarantees convergence to the optimal policy

$${K}_{j}^{*}$$

associated with loop j from state trajectory data generated by the nonlinear system (f, g) of Equation (21), regardless of whether (f, g) is dynamically coupled between loops j=1, . . . , N. Notably, Theorem 2 involves only a fixed single loop 1≤j≤N, both in terms of assumptions and results. Special attention is drawn to the key hypotheses required in Theorem 2: the full-column rank of the matrix [symbol] ∈ [symbol] ^{l}^{ⱼ}^{×n}^{ⱼ} of Equation (11). This matrix places requirements only on the quality of state trajectory data xⱼ in loop j. Thus, the dEIRL algorithm is truly decentralized: The loops j=1, . . . , N may be updated entirely independently, and the designer may focus on data quality in the individual loops rather than for the entire system, providing a practical design benefit.

### Evaluation Studies:

The hypersonic vehicle model used in this study was developed based on NASA Langley's winged-cone aeropropulsive data. This hypersonic vehicle model is a physics-based, stationary model that has served as a standard testbed for hypersonic vehicle control development, later being used in seminal works. The model presented here is identical to that described previously, with two exceptions. First, the elevator-lift increment coefficient C_{L,δ}_{_{E}} of Equation (39) was added to capture nonminimum phase behavior. Second, the angle of attack (AOA) dependence from the thrust coefficient term k of Equation (45) was removed, as AOA dependencies were considered negligible in the original propulsion model, and it was eliminated in subsequent studies.

Instability and nonminimum phase behavior impose respective min/max requirements on closed-loop bandwidth, the combination of which makes the hypersonic vehicle a formidable design challenge even for classical methods. With the additional obstacles of dimensionality, approximation, and numerics facing CT-RL algorithms, this example is significant.

Evaluations were performed in MATLAB R2021a, on an NVIDIA RTX 2060, Intel i7 (ninth Gen) processor. All numerical integrations in this study are performed in MATLAB's adaptive ode45 solver to ensure solution accuracy. All codes developed for this study can be found in the referenced repository.

### Setup:

Hypersonic Vehicle Longitudinal Model: Consider the following hypersonic vehicle longitudinal model according to Equation 32, set forth below, as follows:

$$\dot{V} = \frac{T cos α - D}{m} - \frac{μsin γ}{{r}^{2}}$$

$$\dot{γ} = \frac{L + T sin α}{mV} - \frac{( μ - {V}^{2} r ) cos γ}{{Vr}^{2}}$$

$$\dot{θ} = q$$

$$\dot{q} = \frac{ℳ}{{I}_{yy}}$$

$$\dot{h} = V sin γ ;$$

where V is the vehicle airspeed, γ is the flight path angle (FPA), α is the AOA, θ≙α+γ is the pitch attitude, q is the pitch rate, and h is the vehicle altitude. Here, r(h)=h+R_{E} is the total distance from the Earth's center to the vehicle, with R_{E}=20903500 ft representing the radius of the Earth, and μ=Gm_{E}=1.39×10¹⁶ ft³/s², where G is Newton's gravitational constant and m_{E} is the mass of the Earth. The terms L, D, T, and M are the lift, drag, thrust, and pitching moment, respectively, and are given by equations 33 and 34.

Equation 33, is set forth below, as follows:

$$L = \frac{1}{2} ρ {V}^{2} {SC}_{L} , D = \frac{1}{2} ρ {V}^{2} {SC}_{D} ;$$

Equation 34, is set forth below, as follows:

$$T = \frac{1}{2} ρ {V}^{2} {SC}_{T} , ℳ = \frac{1}{2} ρ {V}^{2} S \overline{c} {C}_{M} ;$$

where ρ is the local air density, S=3603 ft² is the wing planform area, and c̅=80 ft is the mean aerodynamic chord of the wing. Air density ρ and speed of sound a are modeled as functions of altitude h by equations 35 and 36.

Equation 35, is set forth below, as follows:

$$ρ = 0.00238 {e}^{- \frac{h}{24000}} ;$$

Equation 36, is set forth below, as follows:

$$a = 8.99 \times {10}^{- 9} {h}^{2} - 9.16 \times {10}^{- 4} h + 996 ;$$

and Mach number M≙(V/a). The lift, drag, thrust, and pitching moment coefficients are given by equations 37 through 46.

Equation 37, is set forth below, as follows:

$${C}_{L} = {C}_{L , α} + {C}_{L , {δ}_{E}} ;$$

Equation 38, is set forth below, as follows:

$${C}_{L , α} = v α ( 0.493 + \frac{1.91}{M} ) ;$$

Equation 39, is set forth below, as follows:

$${C}_{L , {δ}_{E}} = ( - 0.2 \; 356 {α}^{2} - 0.00 \; 4518 α - 0.02913 ) {δ}_{E} ;$$

Equation 40, is set forth below, as follows:

$${C}_{D} = 0.0 \; 082 ( 171 {α}^{2} + 1.15 α + 1 ) \times ( 0.0 \; 012 {M}^{2} - 0.0 \; 54 M + 1 ) ;$$

Equation 41, is set forth below, as follows:

$${C}_{M} = {C}_{M , α} + {C}_{M , q} + {C}_{M , {δ}_{E}} ;$$

Equation 42, is set forth below, as follows:

$${C}_{M , α} = 1 {0}^{- 4} ( 0.06 - {e}^{- \frac{M}{3}} ) ( - 6565 {α}^{2} + 6875 α + 1 ) ;$$

Equation 43, is set forth below, as follows:

$${C}_{M , q} = ( \frac{q \overline{c}}{2 V} ) ( - 0.0 \; 25 M + 1.37 ) \times ( - 6 \text{.83} {α}^{2} + 0.3 \; 03 α - 0.23 ) ;$$

Equation 44, is set forth below, as follows:

$${C}_{M , {δ}_{E}} = 0.0 \; 292 ( {δ}_{E} - α ) ;$$

Equation 45, is set forth below, as follows:

$$k = 0.0 \; 105 ( 1 + \frac{17}{M} ) ;$$

Equation 46, is set forth below, as follows:

$${C}_{T} = \{ \begin{matrix}k ( 1 + 0.15 ) {δ}_{T} , & {δ}_{T} < 1 \\ k ( 1 + 0.15 {δ}_{T} ) , & {δ}_{T} \geq 1\end{matrix} ;$$

where d_{E} is the elevator deflection, δ_{T} is the throttle setting, and v∈ [symbol] of Equation (39) is an unknown parameter (nominally 1) representing modeling error in the basic lift increment coefficient C_{L,α}. The system of Equation (32) is fifth-order, with states x=[V, γ, θ, q, h]^{T}. The controls are u=[δ_{T}, δ_{E}]^{T}, and the outputs are γ=[V, γ]^{T}. As described previously, a steady level flight cruise condition is studied with qₑ=0, γₑ=0° at Mₑ=15, hₑ=110000 ft, corresponding to an equilibrium airspeed Vₑ=15060 ft/s. At this flight condition, the vehicle is trimmed at αₑ=1.7704° by the controls δ_{T,e}=0.1756 (Tₑ=4.4966×10⁴ lb), δ_{E,e}=−0.3947°.

Hypersonic Vehicle Dynamical Challenges: Instability, Nonminimum Phase, Model Uncertainty: The hypersonic vehicle model studied here encompasses a variety of dynamic challenges facing real-world control designers. First, the hypersonic vehicle is open-loop unstable. Linearization of the model about the equilibrium flight condition has open-loop eigenvalues at s=−0.8291, 0.7165 (short-period modes), s=−0.00001±0.0276 j (phugoid modes), and s=0.0005 (altitude mode). The dominant unstable short-period right half-plane pole (RHPP) at s=0.7165 is associated with the vehicle pitch-up instability (long vehicle forebody, afterward-set center of mass). As is commonplace with tail-controlled aircraft, the elevator-FPA map is a nonminimum phase. The linearized plant has transmission zeros at s=8.3938, −8.4620, with the right half-plane zero (RHPZ) at s=8.3938 being attributable to the elevator-FPA map (negative lift increment in response to pitch-up elevator deflections).

Reducing the lift coefficient v<1 represents degraded lift efficiency and a more difficult vehicle to control dynamically. The evaluations study dEIRL learning performance in the presence of a 10% modeling error v=0.9 and a 25% modeling error v=0.75. For perspective, at v=0.9, the system has its dominant RHPP at s=0.7011 and RHPZ at s=7.9619, and at v=0.75, the system has its dominant RHPP at s=0.6681 and RHPZ at s=7.2664. Thus, the pole/zero ratio drops from 11.72 nominally (v=1) to 11.36 (v=0.9) to 10.88 (v=0.75). Aerodynamic modeling errors are common in aerospace applications, especially in the uniquely challenging hypersonic vehicle context. Between aeropropulsive modeling errors in the tabular data and curve fitting errors, a 10% error in lift coefficient is to be expected. A 25% error is severe, chosen deliberately to push the learning limits of the dEIRL variant of EIRL framework 170.

Decentralized Design Framework: This study implements a decentralized design methodology as a variation of EIRL framework 170, wherein controllers are designed separately for the weakly coupled velocity subsystem (associated with the airspeed V and throttle control δ_{T}) and the rotational subsystem (associated with the flight path angle γ, attitude θ, q, and elevator control δ_{E}). For controllability reasons, altitude h is not fed back into the control design, though altitude is still included in the nonlinear simulation. To achieve zero steady-state error to step reference commands, the plant 205 (see FIG. 2) is augmented at the output with the integrator bank z=∫ydτ=[z_{V}, z_{γ}]^{T}=[∫Vdτ, ∫γdτ]^{T}. For the dEIRL variant of EIRL framework 170, the state/control vectors are partitioned as x₁=[z_{V}, V]^{T}, u₁=δ_{T}(n₁=2, m₁=1) and x₂=[z_{γ}, γ, θ, q]^{T}, u₂=δ_{E}(n₂=4, m₂=1). Applying the linear-quadratic (LQ) servo design framework to each of the loops yields a proportional-integral (PI) velocity controller and a proportional-derivative (PD)/PI inner/outer flight path angle controller structurally identical to those presented. It is these optimal LQ controller parameters that the described methods will learn online.

Hyperparameter Selection: For consistency, all hyperparameters are held constant across evaluations 1 and 2.

Cost Structure: The cost structure is selected by applying principles from classical optimal control. In the velocity loop j=1, the state penalty is Q₁=I₂, and the control penalty is R₁=15. For the flight path angle (FPA) loop j=2, the state penalty is Q₂=diag(1,1,0,0), and the control penalty is R₂=0.01. These parameters yield optimal designs

$${K}_{1}^{*}$$

### of Equation (50) and

$${K}_{2}^{*}$$

of Equation (51), which meet closed-loop step response specifications comparable to prior findings. Specifically, a 90% rise time in velocity t_{r,V,90%}=31.99 seconds, FPA t_{r,γ,90}%=4.56 seconds, a 1% settling time in velocity t_{s,V,90%}=78.18 seconds, FPAt_{s,γ,1%}=8.643 seconds, and percent overshoot in velocity M_{p,V}=4.24% and FPA M_{p,γ}=3.988%. Using the decentralized control method enables initial stabilizing controllers as derived in equations 47, 48, and 49.

Equation 47, is set forth below, as follows:

$${K}_{0 , 1} = [ \begin{matrix}0.2582 & 4.357\end{matrix} ] ;$$

Equation 48, is set forth below, as follows:

$${K}_{0 , 2} = [ \begin{matrix}10. & 26.3299 & 1.6501 & 1.0124\end{matrix} ] ;$$

and

Equation 49, is set forth below, as follows:

$${K}_{0} = [ \begin{matrix}{K}_{0 , 1} & 0 \\ 0 & {K}_{0 , 2}\end{matrix} ] .$$

Excitation Signals: Exploration noise d, used by all methods except the original IRL formulation, is chosen to enhance excitation efficiency. The excitation signals selected are

$${d}_{1} ( t ) = 0.1 sin ( ( \frac{2 π}{25} ) t ) + 0.1 sin ( ( \frac{2 π}{250} ) t ) + 0.2 and {d}_{2} ( t ) = 10 sin ( ( \frac{2 π}{6} ) t ) + 5 cos ( ( \frac{2 π}{50} ) ) t ) + 2 \text{.5} sin ( ( \frac{2 π}{25} ) t ) .$$

For the noises d₁ and d₂ the dominant noise frequencies

$$ω = ( \frac{2 π}{25} ) \approx \frac{0.25 rad}{s} and ω = ( \frac{2 π}{6} ) \approx \frac{1 rad}{s}$$

maximize excitation efficiency for the sensitivity T_{d→y}. For the reference command r used in the MI mode only, the following configuration was utilized:

$${r}_{1} ( t ) = 10 cos ( ( \frac{2 π}{10} ) t ) + 10 sin ( ( 2 π / 25 ) t ) + 50 sin ( ( 2 π / 200 ) t )$$

and r₂(t)=0.02 cos(2π3t)+0.1 sin((2π/6)t)+0.25 sin((2π/15)t), with dominant terms chosen based on the complementary sensitivity map T_{r→γ} (see FIG. 4B).

The term multi-injection excitation, as used throughout this description, refers to the combined use of probing-noise injection and reference-command excitation within the closed-loop structure of FIG. 2. In this configuration, the probing-noise injection introduces excitation through the disturbance-input pathway of plant 205, while the reference-command excitation introduces excitation through the reference pathway that feeds into controller 210. The simultaneous engagement of these two excitation pathways defines the multi-injection mode described herein, distinguishing it from single-injection approaches that apply only the probing-noise component. This combined excitation structure is consistently used to enhance excitation efficiency during online learning and to generate state information suitable for regression-based policy updates.

This selection of dominant probing-noise frequencies and dominant reference-command frequencies is based on input-output properties of the closed-loop system. The dominant components in the probing-noise signals are aligned with the peak regions of the closed-loop P-sensitivity map associated with plant 205 and controller 210. Selecting frequency content near these P-sensitivity peaks maximizes excitation efficiency because these components propagate through the closed-loop structure with comparatively low attenuation. In contrast, the dominant components in the reference-command signals are selected based on the complementary sensitivity map. These components occur in frequency regions where the complementary sensitivity magnitude remains near unity, allowing the injected reference-command excitation to pass through the closed-loop system with minimal attenuation. By selecting probing-noise frequencies that exploit peak P-sensitivity behavior and selecting reference-command frequencies that exploit complementary-sensitivity pass bands, the overall excitation design achieves improved persistent excitation while avoiding heavy attenuation present in other frequency regions.

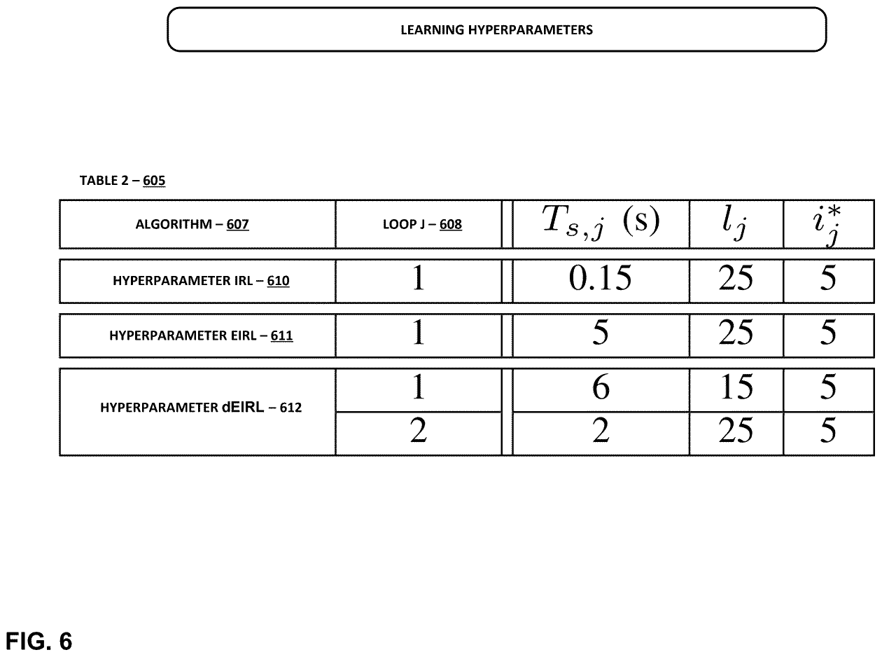

FIG. 6 depicts Table 2 605, which summarizes learning-hyperparameter selections used across algorithm 607 and includes sample periods T_{s,j}, sample counts lⱼ, and iteration limits

$${i}_{j}^{*} .$$

The selection of these hyperparameters may be informed by loop-specific bandwidth characteristics and numerical-conditioning considerations derived from the closed-loop sensitivity maps in FIGS. 4A and 4B. For decentralized operation, each loop j may select T_{s,j} based on the relative closed-loop bandwidth, such that lower-bandwidth loops may use longer sampling periods to improve conditioning, while higher-bandwidth loops may use shorter sampling periods to capture more rapid dynamics. This logic may yield choices such as T_{s,1}=6 s for the velocity loop and T_{s,2}=2 s for the flight-path-angle loop, supporting improved numerical behavior in each regression update. For centralized EIRL, a single sample period such as Tₛ=5 s may be selected to balance excitation and conditioning across all loops simultaneously, representing a compromise between the loop-specific preferences visible in the decentralized case. These sampling-period choices, together with suitable selections of lⱼ and

$${i}_{j}^{*} ,$$

may support stable least-squares regression, improved conditioning of the learning matrices, and consistent excitation throughout the learning process.

For hyperparameter IRL 610, loop j=1 uses a sample period T_{s,1}=0.15 seconds, with l₁=25 samples and

$${i}_{1}^{*} = 5$$

earning iterations. These values reflect conditioning considerations for the original integral reinforcement learning algorithm, which does not enable probing-noise excitation and relies instead on short sampling intervals and initial-condition excitation. Consistent with prior analyses, a short sample period improves numerical conditioning, and twenty-five samples were found sufficient for the regression problem. The critic basis functions B(x,x) of equation (8) are selected to minimize critic-network dimensionality for both IRL and EIRL variants within EIRL framework 170.

For hyperparameter EIRL 611, loop j=1 uses a sample period T_{s,1}=5 seconds, with l₁=25 samples and

$${i}_{1}^{*} = 5$$

iterations. In this configuration, excitable integral reinforcement learning enables probing-noise and reference-command excitation, permitting the designer to select a single sample period that balances the excitation requirements of the system loops. A sample period of five seconds was empirically observed to provide favorable conditioning for EIRL framework 170, lying between the loop-specific sample periods advantageous for decentralized operation.

For hyperparameter dEIRL 612, Table 2 605 shows separate hyperparameter selections for loop i=1 loop j=2. Loop j=1 uses a sample period T_{s,1}=6 seconds, l₁=15 samples, and

$${i}_{1}^{*} = 5$$

iterations. Loop j=2 uses a sample period T_{s,2}=2 seconds, l₂=25 samples, and

$$1 {i}_{2}^{*} = 5$$

iterations. The decentralized excitable integral reinforcement learning architecture enables each loop to select a sample period matched to its bandwidth. As illustrated by the complementary-sensitivity and sensitivity characteristics in FIGS. 4A and 4B, the velocity loop (loop j=1) exhibits substantially lower bandwidth than the flight-path-angle loop (loop j=2). A longer sampling interval is therefore numerically favorable for loop j=1, whereas loop j=2 benefits from a shorter interval. These loop-specific sample-period selections improve conditioning and increase persistence of excitation for each decentralized learning update.

For the number of samples lⱼ, the regression dimensions n̅=21, n̅₁=3, and n̅₂=10 form lower bounds on the required data length for the monolithic and decentralized learning problems. The reduced-dimensional velocity loop in hyperparameter dEIRL 612 benefits from a lower sample requirement, and l₁=15 was observed to yield advantageous conditioning.

System-initialization behavior remains relevant to the hyperparameters represented in Table 2 605. Hyperparameter IRL 610 does not enable probing-noise excitation, so excitation is obtained by initializing the system away from trim. The hypersonic vehicle is initialized at V₀=Vₑ+1000 ft/s and γ₀=γₑ+2°, with all remaining states at trim xₑ. For hyperparameter EIRL 611 and hyperparameter dEIRL 612 within EIRL framework 170, initialization occurs at trim x₀=xₑ, because probing-noise excitation or reference-command excitation is available.

The hyperparameter selections in Table 2 605 support stable and well-conditioned learning behavior. When evaluated using the nominal hypersonic-vehicle model with lift-coefficient parameter v=1, the selections in Table 2 605 help demonstrate improvements in numerical stability and solution optimality. Using hyperparameter IRL 610 as a baseline reveals how hyperparameter EIRL 611 and hyperparameter dEIRL 612 progressively improve conditioning, increase persistent excitation, and enhance performance through the use of multiple-injection excitation and decentralized loop-specific sampling.

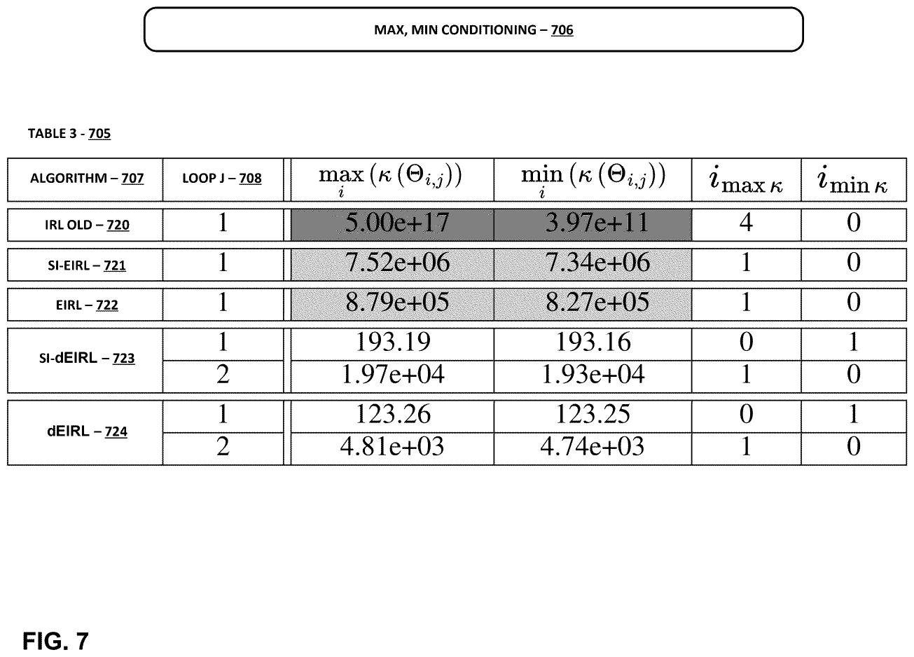

FIG. 7 depicts Table 3, at element 705, which summarizes conditioning characteristics associated with learning matrices Θᵢⱼ generated during policy-update regression within excitable integral reinforcement learning (EIRL) and decentralized excitable integral reinforcement learning (dEIRL), in accordance with aspects of the disclosure. Table 3 705 includes algorithm column algorithm 707, loop index column loop j 708, maximum condition-number column maxᵢ κ(Θᵢⱼ), minimum condition-number column minᵢ κ(Θᵢⱼ), index column iₘₐₓ κ, and index column iₘᵢₙ κ, and each row of Table 3 705 corresponds to one of the evaluated algorithms including IRL old 720, SI-EIRL 721, EIRL 722, SI-dEIRL 723, and dEIRL 724. Table 3 also includes max and min conditioning indicators at element 706, which identify the maximum and minimum condition numbers observed across the evaluated iterations for each algorithm and each loop index j. Element 706 provides a summary of these extremal conditioning values, enabling direct comparison of numerical stability across the IRL, SI-EIRL, EIRL, SI-dEIRL, and dEIRL configurations.

Table 3 705 presents numerical conditioning characteristics that reflect the stability and approximation behavior of the regression process used to update critic parameters. Conditioning plays a central role in continuous-time reinforcement learning performance because the regression step operates on learning matrices Θᵢ whose conditioning affects the accuracy of value-function approximation. In many adaptive-dynamic-programming formulations, the critic-update equation corresponds to least-squares regression of Equation 18, where poorly conditioned Θᵢ can degrade approximation quality or impede convergence.

Table 3 705 illustrates that prior integral reinforcement learning methods can yield learning-matrix condition numbers on the order of κ(Θᵢ)≈10⁵ to 10¹¹ even in low-dimensional academic settings. In the hypersonic vehicle evaluations, the IRL old 720 configuration produces condition numbers on the order of κ(Θᵢ)=5×10¹⁷, which contributes to oscillatory critic weights and failed convergence. In contrast, SI-EIRL 721, EIRL 722, SI-dEIRL 723, and dEIRL 724 exhibit substantially improved conditioning across iterations and across loop indices. The reduced condition numbers shown in Table 3 705 demonstrate improved numerical stability and enhanced solution quality provided by the excitable and decentralized formulations.

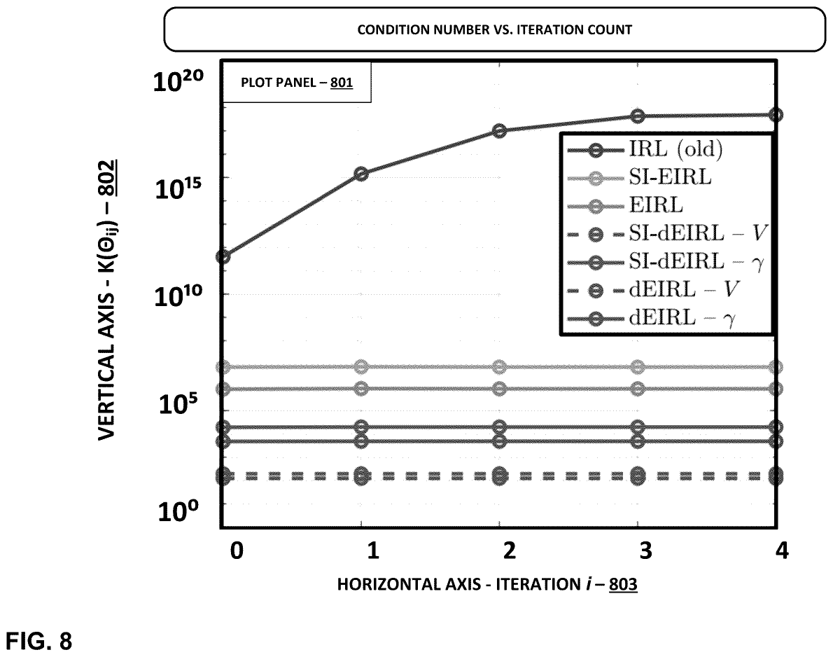

FIG. 8 depicts plot panel 801, which presents evaluation 1 condition number versus iteration count i for the learning matrices used within excitable integral reinforcement learning (EIRL) and decentralized excitable integral reinforcement learning (dEIRL), in accordance with aspects of the disclosure. Plot panel 801 includes vertical axis label κ(Θᵢⱼ) 802 and horizontal axis label iteration i 803, and displays the iteration-wise conditioning characteristics of the learning matrices Θᵢ used for Equation 19 in integral reinforcement learning (IRL) and EIRL, and the matrices Θᵢⱼ for Equation 28 in dEIRL for loop index j. FIG. 8 corresponds to the conditioning summary in Table 3 705 of FIG. 7 and illustrates conditioning behavior for iterations 0≤i≤i*−1, including the iteration indices iₘₐₓκ and iₘᵢₙκ associated with maximum and minimum condition numbers.

Conditioning analysis plays a central role in continuous-time reinforcement learning performance because the regression step that updates critic parameters operates directly on the learning matrices Θᵢⱼ, whose conditioning influences approximation quality and convergence behavior. FIG. 8 shows that the original IRL configuration produces the most severe conditioning degradation, with κ(Θᵢ) increasing from approximately 4×10¹¹ at iteration i=0 to approximately 5×10¹⁷ at iteration i=4. This increase, previously associated with insufficient persistent excitation as the system state approaches the origin under stabilizing controller Kₒ without probing noise, demonstrates the numerical difficulty of classical IRL when operated without explicit excitation signals.

Single-injection EIRL achieves substantially improved conditioning. In evaluation 1, conditioning remains near 7.5×10⁶, representing an improvement of approximately eleven orders of magnitude relative to prior adaptive-dynamic-programming methods relying on the baseline IRL formulation. Multi-injection excitation further strengthens conditioning properties, reducing the magnitude of κ(Θᵢⱼ) across both IRL-derived and EIRL-derived learning processes.

In loop j=2, single-injection decentralized extended integral reinforcement learning (SI-dEIRL) exhibits conditioning near 2×10⁴, while decentralized extended integral reinforcement learning (dEIRL) in the same loop achieves conditioning near 4.75×10³. In loop j=1, SI-dEIRL produces conditioning near 193 and dEIRL produces conditioning near 123. Although the relative reduction is less dramatic in loop j=1 due to favorable initial conditioning, the approximately 36% reduction remains meaningful and reflects the benefits of combining excitation with decentralized update structure.

Decentralization yields even larger reductions in conditioning than multi-injection alone. Transitioning from single-injection EIRL to SI-dEIRL reduces conditioning from approximately 7.5×10⁶ to approximately 193 in loop j=1 and to approximately 2×10⁴ in loop j=2, corresponding to reductions of approximately four orders and two orders of magnitude, respectively. Transitioning from EIRL to dEIRL further reduces conditioning from approximately 8.75×10⁵ to approximately 123 in loop j=1 and to approximately 4.75×10³ in loop j=2, yielding reductions of approximately three and two orders of magnitude.

Across the full progression from the original IRL method to dEIRL, the cumulative reduction in worst-case conditioning reaches approximately fifteen orders of magnitude in the velocity loop j=1 and approximately fourteen orders of magnitude in the flight-path-angle loop j=2. The combined application of multi-injection excitation and decentralized loop-specific updates thus mitigates conditioning challenges associated with continuous-time reinforcement learning and improves numerical behavior in both loops.

To evaluate convergence and solution quality, a decentralized linear-quadratic (LQ) design computed through EIRL framework 170 is used as a reference. The optimal LQ controllers correspond to Equation 50, Equation 51, and Equation 52, reproduced below for clarity.

Equation 50, is set forth below, as follows:

$${K}_{1}^{*} = [ \begin{matrix}0.2582 & 4.3577\end{matrix} ] ;$$

Equation 51, is set forth below, as follows:

$${K}_{2}^{*} = [ \begin{matrix}10. & 26.3393 & 1.6514 & 0.9921\end{matrix} ] ;$$

and

Equation 52, is set forth below, as follows:

$$K *= [ \begin{matrix}0.2581 & 4.3622 & 0.0074 & 0.0814 & 0. & 0.0001 \\ - 0.2865 & - 1.112 & 9.9959 & 26.312 & 1.6512 & 0.9921\end{matrix} ] .$$

These optimal controller matrices serve as the performance benchmark for evaluating the learned policies across the EIRL and dEIRL configurations illustrated in FIG. 8.

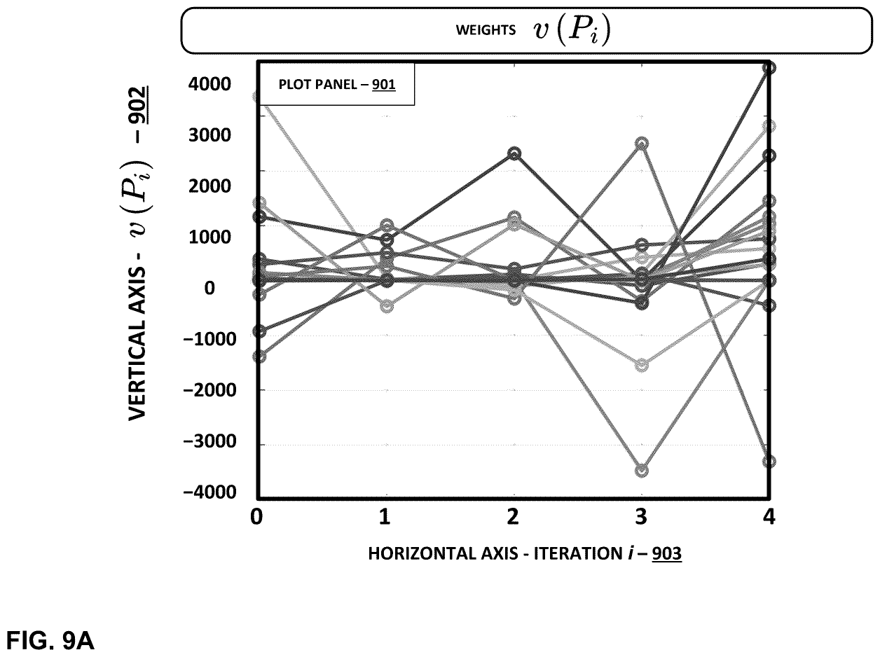

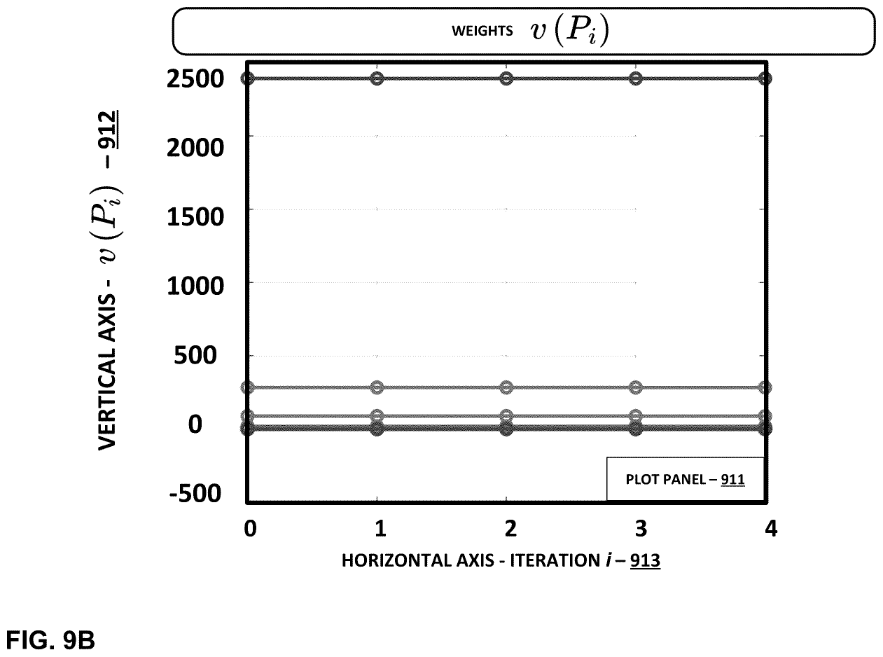

FIGS. 9A and 9B depict plot panel 901 and plot panel 911, respectively, which present evaluation 1 weight responses v(Pᵢ) associated with critic-parameter updates within integral reinforcement learning (IRL), excitable integral reinforcement learning (EIRL), and single-injection excitable integral reinforcement learning (SI-EIRL), in accordance with aspects of the disclosure. Plot panel 901 in FIG. 9A includes vertical axis label v(Pᵢ) 902 and horizontal axis label iteration i 903. Plot panel 911 in FIG. 9B includes vertical axis label v(Pᵢ) 912 and horizontal axis label iteration i 913. FIG. 9A illustrates critic-weight trajectories generated under an IRL configuration, while FIG. 9B illustrates critic-weight trajectories generated under an SI-EIRL configuration.

The convergence performance of critic-weight learning is evaluated by examining the weight responses v(Pᵢ) shown in FIG. 9A and FIG. 9B. Under the IRL configuration depicted in plot panel 901 of FIG. 9A, poor conditioning of the learning matrices, as characterized in FIG. 8 and Table 3 705 of FIG. 7, produces weight-update oscillations that do not converge to stable values. These fluctuations arise from the elevated condition numbers associated with Θ₁ during the regression step, which degrade approximation accuracy and impede critic-parameter convergence.

In contrast, plot panel 911 of FIG. 9B shows that the SI-EIRL configuration yields substantially improved convergence behavior. The weight trajectories v(Pᵢ) in FIG. 9B converge smoothly over iterations and exhibit stable evolution consistent with the theoretical guarantees associated with excitable integral reinforcement learning. The improved conditioning properties demonstrated in FIG. 8 contribute directly to this stabilized weight-learning behavior.

The optimality of control solutions obtained through these learning processes is assessed by comparing the learned policies to the decentralized linear-quadratic (LQ) reference solutions corresponding to Equation 50, Equation 51, and Equation 52. Across the evaluated methods, each learning configuration converges toward its respective optimal policy K*. For SI-EIRL, the largest final policy error ∥K_{i*}−K*∥ is approximately 4.63×10⁻³. For decentralized excitable integral reinforcement learning (dEIRL), the final policy errors are approximately

$$‖ {K}_{i {,}^{*} 1} - {K}_{1}^{*} ‖ = 1.11 \times 1 {0}^{- 6} and ‖ {K}_{i {,}^{*} 2} - {K}_{2}^{*} ‖ = 2.7 \times 1 {0}^{- 5} ,$$

reflecting high-accuracy convergence consistent with the underlying theoretical results.

The data-efficiency and training-time characteristics of the learning processes are evaluated using trajectory information, as summarized in Table 2 605 of FIG. 6. Each evaluated method requires at most l=25 state-action samples (x, u) to perform critic-parameter updates, and all configurations converge within a maximum training time of approximately 2.74 seconds, with the dEIRL configuration of EIRL framework 170 requiring the longest duration. These results demonstrate that the excitable and decentralized formulations achieve efficient data usage and rapid training while yielding weight-learning convergence as illustrated in FIG. 9A and FIG. 9B.

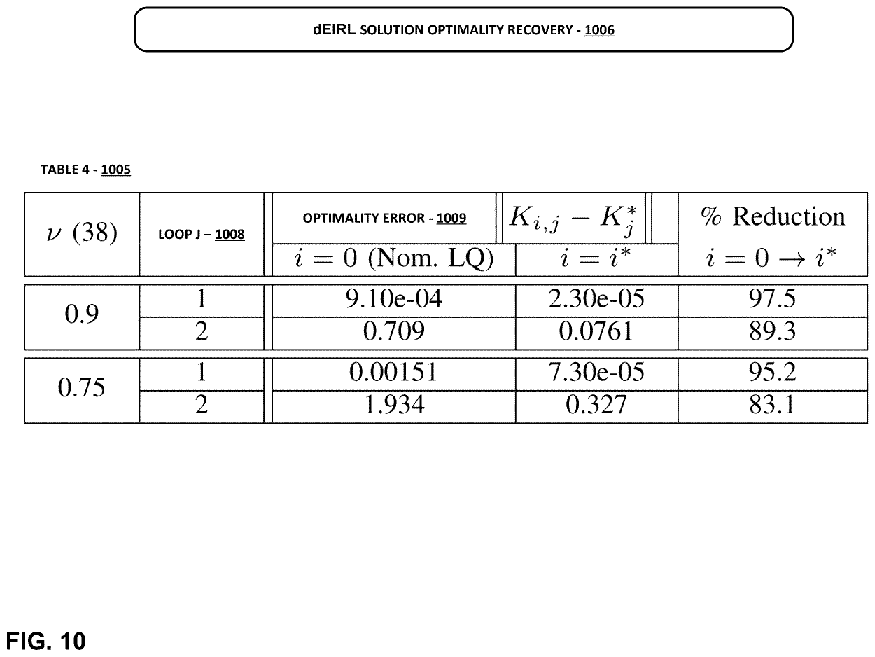

FIG. 10 depicts Table 4, at element 1005, within dEIRL solution optimality recovery 1006, which shows the policy error reduction

$${K}_{i , j} - {K}_{j}^{*}$$

from the initial policies K_{0,1}, K_{0,2}, in accordance with aspects of the disclosure. In particular, initial policies K_{0,1}, K_{0,2} correspond to the nominal decentralized LQR policies and the Table depicts the policy error reduction from the initial policies K_{0,1}, K_{0,2} to the final policies K_{i*,1}, and K_{i*,2}, respectively.

Evaluation 2—dEIRL Generalization Performance: This evaluation focuses on the generalization performance of the flagship method as implemented by the dEIRL variant of EIRL framework 170, after establishing a systematic framework for learning improvement. Having demonstrated dEIRL's learning capabilities on the nominal HSV model with v=1 according to Equation (38), the analysis now shifts to assessing how dEIRL generalizes when the model deviates from nominal conditions. Specifically, the model is perturbed to v=0.9, representing a 10% modeling error, and to v=0.75, representing a 25% modeling error. These perturbations introduce a more challenging control problem.

Conditioning Analysis: For v=0.9, the maximum conditioning values of dEIRL are

$${max}_{i} ( κ ( {Θ}_{i , 1} ) ) = 111.13 {max}_{i} ( κ ( {Θ}_{i , 2} ) ) = 6.20 \times 1 {0}^{3} .$$

For v=0.75, the maximum conditioning values are

$${max}_{i} ( κ ( {Θ}_{i , 1} ) ) = 90.89 {max}_{i} ( κ ( {Θ}_{i , 2} ) ) = 8.93 \times 1 {0}^{3} .$$

Overall, the conditioning performance in the velocity loop j=1 (1008) has remained largely unchanged, as shown in Table 3. Even in the higher-dimensional, unstable, nonminimum-phase FPA loop j=2 (1008), which is directly influenced by the lift-coefficient modeling error ν, conditioning has only slightly degraded. These results indicate that dEIRL retains favorable conditioning properties that effectively generalize, even in the presence of substantial modeling errors.

Convergence and Solution Optimality Analysis: When running dEIRL for i*=5 iterations and v=0.9, results align with Equations 53 through 56.

Equation 53, is set forth below, as follows:

$${K}_{{i}^{*} , 1} = [ \begin{matrix}0.2582 & 4.3579\end{matrix} ] ;$$

Equation 54, is set forth below, as follows:

$${K}_{1}^{*} = [ \begin{matrix}0.2582 & 4.358\end{matrix} ] ;$$

Equation 55, is set forth below, as follows:

$${K}_{{i}^{*} , 2} = [ \begin{matrix}10.0171 & 27.1052 & 1.5828 & 0.9741\end{matrix} ] ;$$

and

Equation 56, is set forth below, as follows:

$${K}_{2}^{*} = [ \begin{matrix}10. & 27.0327 & 1.5685 & 0.9671\end{matrix} ] .$$

When running the dEIRL variant of EIRL framework 170 for i*=5 iterations and v=0.75, results align with Equations 57 through 60.

Equation 57, is set forth below, as follows:

$${K}_{{i}^{*} , 1} = [ 0.25824 \text{.3585} ] ;$$

Equation 58, is set forth below, as follows:

$${K}_{1}^{*} = [ \begin{matrix}0.2582 & 4.3586\end{matrix} ] ;$$

Equation 59, is set forth below, as follows:

$${K}_{{i}^{*} , 2} = [ \begin{matrix}10.0397 & 28.5706 & 1.4712 & 0.9539\end{matrix} ] ;$$

and

Equation 60, is set forth below, as follows:

$${K}_{2}^{*} = [ \begin{matrix}10. & 28.2496 & 1.4303 & 0.9238\end{matrix} ] .$$

Policy Error Reduction: Table 4 1005 presents the reduction in policy error, denoted as

$$\vert {K}_{i , j} - {K}_{j}^{*} \vert ,$$

between the initial policies K_{0,1} of Equation (47) and K_{0,2} of Equation (48), which represent the nominal decentralized LQR policies, and the final policies K_{i*,1} of Equations (53, 57) and K_{i*,2} of Equations (55, 59), respectively.

Remark 9—dEIRL Solution Optimality Recovery: As seen in Table 4, for a 10% modeling error (v=0.9), dEIRL reduces optimality error 1009 by at least one order of magnitude in each loop. When considering a 25% modeling error (v=0.75), dEIRL reduces optimality error 1009 by over 80% in each loop, with particularly significant reductions observed in the velocity loop j=1 compared to the nonminimum phase flight path angle loop j=2 (1008).

This feature holds substantial practical utility. Previously, when designers synthesized an initial LQ policy K_{0,1} (e.g., optimal with respect to the nominal linear drift dynamics Aⱼⱼ), the design typically could not be improved upon in real-world applications. However, using a nominal model (v=1), dEIRL now outputs a policy K_{i*,j} that is much closer to the optimal

$${K}_{j}^{*}$$

than the original estimate K_{0,j}.

Closed-Loop Performance Analysis: The following analysis evaluates how dEIRL achieves optimal closed-loop performance recovery. Specifically, a 100 ft/s step-velocity command and a 1° step-FPA command are applied to the nonlinear, coupled perturbed HSV models under simulation, with the nominal LQ policies K_{0,j}(v=1), dEIRL policies K_{i*,j}, and optimal LQ policies

$${K}_{j}^{*} ( v \neq 1 ) .$$

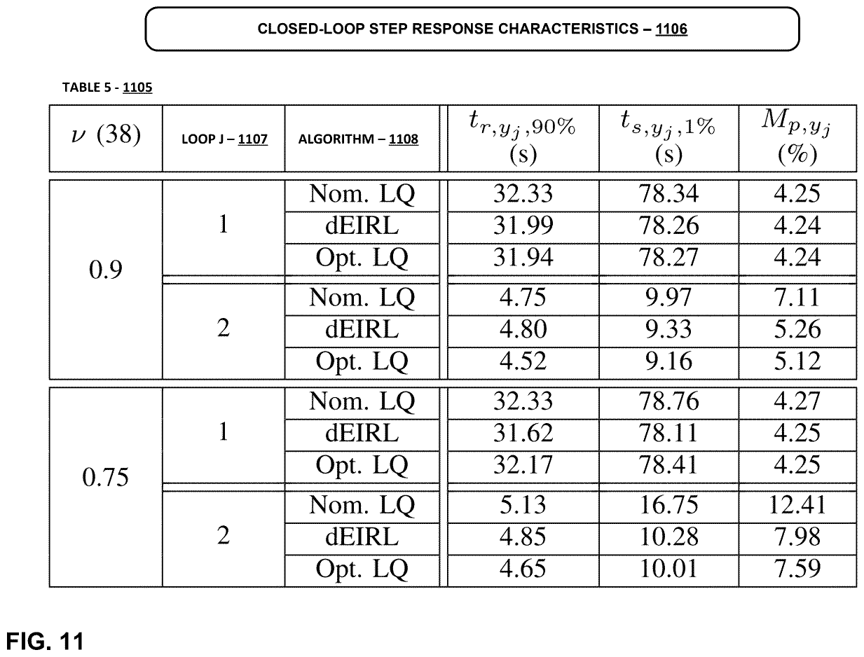

FIG. 11 depicts Table 5, at element 1105, presented using closed-loop step response characteristics 1106, which shows the closed-loop step response characteristics in each loop j, in accordance with aspects of the disclosure. In particular, initial policies K_{0,1}, K_{0,2} correspond to the nominal decentralized LQR policies and the Table depicts the policy error reduction from the initial policies K_{0,1}, K_{0,2} to the final policies K_{i*,1}, and K_{i*,2}, respectively.

In particular, Table 5 lists the closed-loop step response characteristics for each loop j 1107 and each algorithm 1108, including the 90% rise time t_{r,y}_{ⱼ}_{,90%}, the 1% settling time t_{s,y}_{ⱼ}_{,1%}, and percent overshoot M_{p,y}_{ⱼ}(j=1,2). Table 5 reveals that dEIRL effectively restores the closed-loop step response characteristics of the optimal LQ policies. Performance recovery is particularly evident in the FPA loop j=2, where, for a significant modeling error of v=0.75, the nominal LQ policy's performance is notably inferior to that of dEIRL and the optimal. Specifically, the 1% FPA settling time t_{s,γ,1%}, 1% for the nominal LQ policy approaches 17 seconds, while it is only 10 seconds for both dEIRL and the optimal LQ. Similarly, the FPA percent overshoot M_{p,γ} exceeds 12% for the nominal LQ policy but remains at only 8% for dEIRL and the optimal LQ.

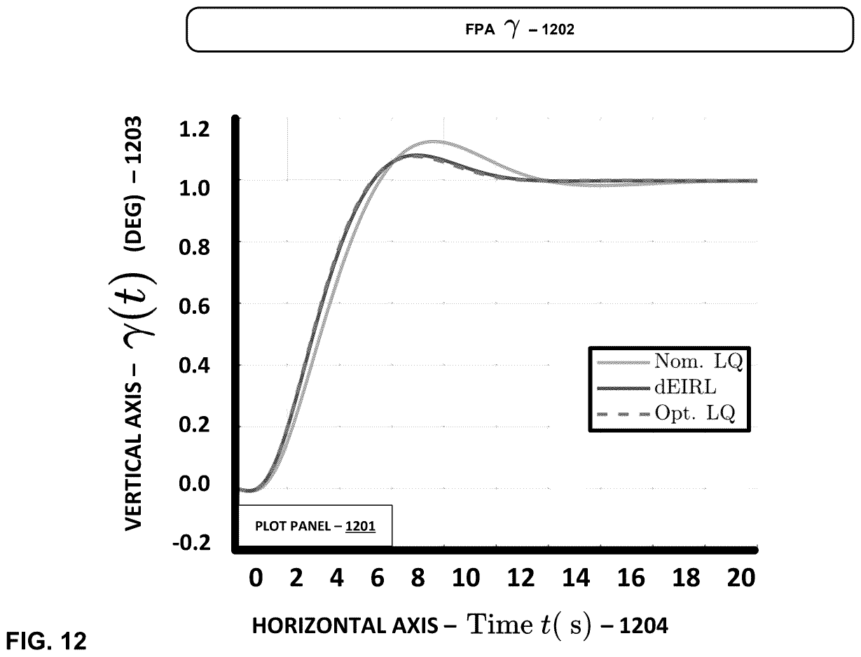

FIG. 12 depicts closed-loop 1° FPA step response behavior for a 25% lift-coefficient modeling error ν=0.75, in accordance with aspects of the disclosure. FIG. 12 includes plot panel 1201, FPA γ 1202, vertical axis label γ(t) (deg) 1203, and horizontal axis label time t (s) 1204. In particular, FIG. 12, including plot panel 1201 and FPA γ 1202, provides the corresponding FPA step response for the 25% lift-coefficient modeling error (v=0.75). Consistent with the numerical data in Table 5, FIG. 12 demonstrates that dEIRL has qualitatively recovered optimal closed-loop step response performance despite the significant 25% modeling error. As an additional observation, the first t=1 s of the FPA response in FIG. 12, as plotted along horizontal axis time t (s) 1204 and vertical axis γ(t) (deg) 1203, displays a typical inverse nonminimum-phase behavior attributed to the parasitic downward lift generated by pitch-up elevator deflections δ_{E}.

CT-RL algorithms using MI approaches: In such a way, EIRL framework 170 implements to the end user a suite of novel continuous-time reinforcement learning (CT-RL) algorithms that employ multi-injection (MI) approaches to enhance learning exploration efficiency. When the system dynamically partitions into distinct loops, the decentralization variant of EIRL framework 170 further augments learning efficiency. These algorithms are accompanied by results establishing theoretical convergence, solution optimality, and guarantees of closed-loop stability.

Quantitative performance and effectiveness of MI and decentralization: The extensive quantitative performance evaluations across four algorithms demonstrate that the use of MI and decentralization, as implemented in the dEIRL variant of EIRL framework 170, leads to significant reductions in conditioning by multiple orders of magnitude. These evaluations confirm both convergence and stability, aligning with theoretical analyses, and indicate that the algorithms utilized by EIRL framework 170 reliably generalize by recovering the optimal policy and closed-loop performance, even in the presence of severe modeling errors. This reliability primarily stems from the MI variant of EIRL framework 170, which improves excitation and thus enhances learning exploration. Where decentralization is physically feasible, EIRL framework 170 enables the designer to select learning parameters that are optimally suited to the inherent physics of each loop, resulting in improved control performance.

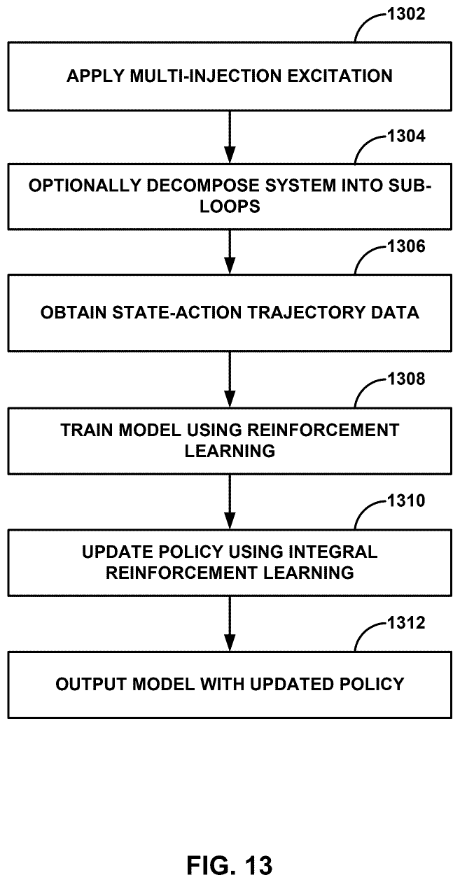

FIG. 13 is a flow diagram illustrating an example method for refining a control policy for a continuous-time system, in accordance with aspects of this disclosure. FIG. 13 is described with respect to computing device 100 of FIG. 1, including processing circuitry 102, EIRL framework 170, policy determination and refinement 175, trained AI model 176, multi-injection module 190, reinforcement learning module 195, and configuration settings 196. However, the techniques of FIG. 13 may be performed by different components of computing device 100 or by additional or alternative systems configured for continuous-time reinforcement learning, multi-injection excitation, and decentralized control-policy refinement.

Processing circuitry of computing device 100 may be configured to apply multi-injection excitation (1302). For example, multi-injection module 190 may apply multi-injection excitation to a continuous-time system to generate persistently excited state information suitable for data-driven policy refinement.

Processing circuitry of computing device 100 may be configured to optionally decompose the system into sub-loops (1304). For example, EIRL framework 170 may optionally decompose the continuous-time system into a plurality of sub-loops based on physical or functional partitions, and may configure policy determination and refinement 175 to operate on respective sub-loop dynamics.

Processing circuitry of computing device 100 may be configured to obtain state-action trajectory data (1306). For example, reinforcement learning module 195 may obtain state-action trajectory data from the continuous-time system while operating under an operating policy managed by policy determination and refinement 175.

Processing circuitry of computing device 100 may be configured to a train model using reinforcement learning (1308). For example, reinforcement learning module 195 may train a model using reinforcement learning to obtain an updated policy for a nonlinear continuous-time system, based at least in part on the state-action trajectory data and configuration settings 196.

Processing circuitry of computing device 100 may be configured to update policy using integral reinforcement learning (1310). For example, policy determination and refinement 175 may update the operating policy using an integral reinforcement learning process configured to reduce approximation error during learning based at least in part on the state-action trajectory data outputs of reinforcement learning module 195.

Processing circuitry of computing device 100 may be configured to output model with updated policy (1312). For example, EIRL framework 170 may cause trained AI model 176 to be stored in storage devices 108 or exported via network interface 106 as a model with the updated policy for deployment or downstream closed-loop control.

In this way, FIG. 13 illustrates a method for refining a control policy for a continuous-time system using multi-injection excitation, optional decentralization into sub-loops, reinforcement-learning-based model training, and integral reinforcement learning to reduce approximation error. The method enables improved convergence, robustness, and closed-loop performance even in the presence of nonlinear dynamics and modeling uncertainty.

This disclosure includes the following examples.

Example 1—A method for refining a control policy for a continuous-time system, the method comprising: applying multi-injection excitation to a continuous-time system to generate persistently excited state information; optionally decomposing the continuous-time system into a plurality of sub-loops based on physical or functional partitions; obtaining state-action trajectory data from the continuous-time system while operating under an operating policy; training a model using reinforcement learning to obtain an updated policy for a nonlinear continuous-time system; updating the operating policy using an integral reinforcement learning process configured to reduce approximation error during learning based at least in part on the state-action trajectory data; and outputting the model with the updated policy.

Example 2—The method of example 1, wherein the multi-injection excitation includes concurrently injecting a probing-noise signal and injecting a reference-command excitation into the continuous-time system such that a combined excitation produces persistently excited state information for use in the integral reinforcement learning process.

Example 3—The method of example 2, further comprising adjusting an excitation frequency of the probing signal or a reference-based excitation based on a sensitivity response of the continuous-time system.

Example 4—The method of example 1, wherein decomposing the continuous-time system into the plurality of sub-loops comprises segmenting system dynamics into translational and rotational partitions.

Example 5—The method of example 4, wherein updating the operating policy comprises applying a decentralized integral reinforcement learning process in each sub-loop.

Example 6—The method of example 1, wherein decomposing the continuous-time system into the plurality of sub-loops comprises segmenting the continuous-time system into velocity and flight path angle control loops.

Example 7—The method of example 1, wherein decomposing the continuous-time system into the plurality of sub-loops comprises decentralizing control synthesis for the continuous-time system.

Example 8—The method of example 1, wherein obtaining the state-action trajectory data comprises collecting state and control input measurements over a plurality of sample instants.

Example 9—The method of example 1, wherein training the model using reinforcement learning comprises reusing a single set of state-action trajectory data across multiple policy update iterations.

Example 10—The method of example 1, wherein training the model using reinforcement learning comprises generating an integral reinforcement signal based on a cost representation associated with the continuous-time system.

Example 11—The method of example 1, wherein training the model using reinforcement learning comprises applying basis functions that include monomials of degree two.

Example 12—The method of example 1, wherein updating the operating policy comprises determining critic parameters by solving a regression equation formed using the state-action trajectory data and known affine system dynamics to enable reuse of fixed trajectory information during the integral reinforcement learning process.

Example 13—The method of example 1, wherein updating the operating policy comprises determining critic parameters by solving a regression equation using the state-action trajectory data.

Example 14—The method of example 1, wherein the nonlinear continuous-time system comprises an affine nonlinear system of the form x=f(x)+g(x)u, wherein the drift term f(x) and input term g(x) enable formation of regression updates using known affine dynamics and support reuse of fixed state-action trajectory data during the integral reinforcement learning process.

Example 15—An apparatus for refining a control policy for a continuous-time system, the apparatus comprising: at least one memory storing instructions; and processing circuitry in communication with the at least one memory, the processing circuitry configured to: apply multi-injection excitation to a continuous-time system to generate persistently excited state information; decompose the continuous-time system into a plurality of sub-loops based on physical or functional partitions; obtain state-action trajectory data from the continuous-time system while operating under an operating policy; train a model using reinforcement learning to obtain an updated policy for a nonlinear continuous-time system; update the operating policy using an integral reinforcement learning process configured to reduce approximation error during learning based at least in part on the state-action trajectory data; and output the model with the updated policy.

Example 16—The apparatus of example 15, wherein the processing circuitry is configured to apply the multi-injection excitation by concurrently injecting a probing-noise signal and injecting a reference-command excitation into the continuous-time system to produce persistently excited state information for use in the integral reinforcement learning process.

Example 17—The apparatus of example 15, wherein the processing circuitry is configured to decompose the continuous-time system into translational and rotational sub-loops or into velocity and flight path angle sub-loops.

Example 18—The apparatus of example 15, wherein the processing circuitry is configured to obtain the state-action trajectory data by collecting nonlinear state and control information generated under an initial stabilizing policy.

Example 19—The apparatus of example 15, wherein the processing circuitry is configured to update the operating policy by forming a regression update using nominal linearization information associated with the continuous-time system and determining critic parameters by solving a regression equation using the state-action trajectory data.

Example 20—A non-transitory computer-readable medium storing instructions that, when executed by processing circuitry, cause the processing circuitry to: apply multi-injection excitation to a continuous-time system to generate persistently excited state information; decompose the continuous-time system into a plurality of sub-loops based on physical or functional partitions; obtain state-action trajectory data from the continuous-time system while operating under an operating policy; train a model using reinforcement learning to obtain an updated policy for a nonlinear continuous-time system; update the operating policy using an integral reinforcement learning process configured to reduce approximation error during learning based at least in part on the state-action trajectory data; and output the model with the updated policy.

Example 21—A computer program product comprising one or more instructions that, when executed by at least one processor, cause the at least one processor to perform any of the methods of examples 1-14.

Example 22—A device comprising means for performing any of the methods of examples 1-14.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A method for refining a control policy for a continuous-time system, the method comprising:
applying multi-injection excitation to a continuous-time system to generate persistently excited state information;
optionally decomposing the continuous-time system into a plurality of sub-loops based on physical or functional partitions;
obtaining state-action trajectory data from the continuous-time system while operating under an operating policy;
training a model using reinforcement learning to obtain an updated policy for a nonlinear continuous-time system;
updating the operating policy using an integral reinforcement learning process configured to reduce approximation error during learning based at least in part on the state-action trajectory data; and
outputting the model with the updated policy.

2. The method of claim 1, wherein the multi-injection excitation includes concurrently injecting a probing-noise signal and injecting a reference-command excitation into the continuous-time system such that a combined excitation produces persistently excited state information for use in the integral reinforcement learning process.

3. The method of claim 2, further comprising adjusting an excitation frequency of the probing signal or a reference-based excitation based on a sensitivity response of the continuous-time system.

4. The method of claim 1, wherein decomposing the continuous-time system into the plurality of sub-loops comprises segmenting system dynamics into translational and rotational partitions.

5. The method of claim 4, wherein updating the operating policy comprises applying a decentralized integral reinforcement learning process in each sub-loop.

6. The method of claim 1, wherein decomposing the continuous-time system into the plurality of sub-loops comprises segmenting the continuous-time system into velocity and flight path angle control loops.

7. The method of claim 1, wherein decomposing the continuous-time system into the plurality of sub-loops comprises decentralizing control synthesis for the continuous-time system.

8. The method of claim 1, wherein obtaining the state-action trajectory data comprises collecting state and control input measurements over a plurality of sample instants.

9. The method of claim 1, wherein training the model using reinforcement learning comprises reusing a single set of state-action trajectory data across multiple policy update iterations.

10. The method of claim 1, wherein training the model using reinforcement learning comprises generating an integral reinforcement signal based on a cost representation associated with the continuous-time system.

11. The method of claim 1, wherein training the model using reinforcement learning comprises applying basis functions that include monomials of degree two.

12. The method of claim 1, wherein updating the operating policy comprises determining critic parameters by solving a regression equation formed using the state-action trajectory data and known affine system dynamics to enable reuse of fixed trajectory information during the integral reinforcement learning process.

13. The method of claim 1, wherein updating the operating policy comprises determining critic parameters by solving a regression equation using the state-action trajectory data.

14. The method of claim 1, wherein the nonlinear continuous-time system comprises an affine nonlinear system of the form x=f(x)+g(x)u, wherein the drift term f(x) and input term g(x) enable formation of regression updates using known affine dynamics and support reuse of fixed state-action trajectory data during the integral reinforcement learning process.

15. An apparatus for refining a control policy for a continuous-time system, the apparatus comprising:
at least one memory storing instructions; and
processing circuitry in communication with the at least one memory, the processing circuitry configured to:
apply multi-injection excitation to a continuous-time system to generate persistently excited state information;
decompose the continuous-time system into a plurality of sub-loops based on physical or functional partitions;
obtain state-action trajectory data from the continuous-time system while operating under an operating policy;
train a model using reinforcement learning to obtain an updated policy for a nonlinear continuous-time system;
update the operating policy using an integral reinforcement learning process configured to reduce approximation error during learning based at least in part on the state-action trajectory data; and
output the model with the updated policy.

16. The apparatus of claim 15, wherein the processing circuitry is configured to apply the multi-injection excitation by concurrently injecting a probing-noise signal and injecting a reference-command excitation into the continuous-time system to produce persistently excited state information for use in the integral reinforcement learning process.

17. The apparatus of claim 15, wherein the processing circuitry is configured to decompose the continuous-time system into translational and rotational sub-loops or into velocity and flight path angle sub-loops.

18. The apparatus of claim 15, wherein the processing circuitry is configured to obtain the state-action trajectory data by collecting nonlinear state and control information generated under an initial stabilizing policy.

19. The apparatus of claim 15, wherein the processing circuitry is configured to update the operating policy by forming a regression update using nominal linearization information associated with the continuous-time system and determining critic parameters by solving a regression equation using the state-action trajectory data.

20. A non-transitory computer-readable medium storing instructions that, when executed by processing circuitry, cause the processing circuitry to:
apply multi-injection excitation to a continuous-time system to generate persistently excited state information;
decompose the continuous-time system into a plurality of sub-loops based on physical or functional partitions;
obtain state-action trajectory data from the continuous-time system while operating under an operating policy;
train a model using reinforcement learning to obtain an updated policy for a nonlinear continuous-time system;
update the operating policy using an integral reinforcement learning process configured to reduce approximation error during learning based at least in part on the state-action trajectory data; and
output the model with the updated policy.
